(19) United States
(12) Patent Application Publication
(10) Pub. No.: US 2025/0155414 A1
(43) Pub. Date: May 15, 2025

(54) REACTIVE THIN FILM COATINGS ON CATALYST LIBRARIES FOR HIGH THROUGHPUT SCREENING

(71) Applicant: NORTHWESTERN UNIVERSITY, Evanston, IL (US)

(72) Inventors: Chad A. Mirkin, Wilmette, IL (US); Peter T. Smith, Evanston, IL (US)

(21) Appl. No.: 18/840,111

(22) PCT Filed: Feb. 22, 2023
(86) PCT No.: PCT/US2023/013574

§ 371 Date: Aug. 21, 2024

Related U.S. Application Data
(60) Provisional application No. 63/413,799, filed on Oct. 6, 2022.
(60) Provisional application No. 63/312,666, filed on Feb. 22, 2022.

(51) Int. Cl. G01N 31/10

(52) U.S. Cl. CPC G01N 31/10

(57) ABSTRACT

A method of simultaneously testing catalytic activity and/or selectivity of a plurality of catalyst includes coating a substrate having the plurality of catalyst with a polymer thin film having one or more reactive probes, subjecting the coated substrate to catalysis conditions corresponding to the target catalytic activity and/or selectivity, and imaging the coated substrate for the optical signal. Each reactive probe has a signaling component that generates an optical signal upon reaction of the probes with a product of the target catalytic activity and/or selectivity, thereby allowing sensing and signaling of the product of the target catalytic activity and/or selectivity. The presence of an optical signal in one or more regions of the coated substrate is indicative of catalysts of the plurality of catalyst in the one or more regions being active for the target catalytic activity and/or selectivity.

### CROSS-REFERENCE TO RELATED APPLICATION

The benefit of priority to U.S. Provisional Patent Application No. 63/312,666 filed Feb. 22, 2022, and U.S. Provisional Patent Application No. 63/413,799 filed Oct. 6, 2022, are hereby claimed and the disclosure of which are each incorporated herein by reference in their entireties.

### FIELD

The disclosure relates to catalyst screening methods with high throughput using fluorescent detection of reaction products.

### BACKGROUND

Catalysts are required for numerous technologies, both existing and emerging, and the traditional methods for synthesizing and characterizing catalyst performance are slow. Materials discovery drives technological advancement; however, the process is slowed by two fundamental challenges: synthesis and characterization. Traditional materials design and discovery can be accomplished sequentially, or the large-scale synthesis of materials libraries combined with high throughput screening can expedite optimization. Electrocatalyst discovery is particularly slow because screening activity and selectivity must be done serially, and time-consuming experiments are needed for product detection.

Current electrocatalyst screening techniques use soluble and reversible pH indicators to indirectly visualize catalytic performance. However, because the indicators are soluble and reversible, it is necessary to image the library during the catalytic experiment and useful information is only achieved in a brief period at the onset of the catalysis. Also, the indicators only sense pH changes at the catalyst surface instead of the desired products of interest. This limits the information obtained in each screen and also requires the use of relatively small libraries.

Techniques are also known that utilize a scanning droplet cell, where a small droplet of electrolyte is moved across the surface of a library and at specific locations the catalyst activity is measured. This is a serial technique that can be very slow, and it only measures the current response to an applied potential, so there is no information regarding product electivity.

### SUMMARY

It is appealing to drive chemical reactions using electricity because abundant feedstocks can be transformed with renewable energy, reducing reliance on fossil fuels, mitigating climate change, and offering on-demand synthesis in remote locations. The O₂ reduction reaction (ORR) and CO₂ reduction reaction (CO₂RR) are of great interest for a decarbonized economy. ORR can convert O₂ into H₂O, which is crucial for fuel cells and batteries. ORR also converts O₂ into H₂O₂, which is needed as an oxidant for synthesis and bleaching. Electrosynthesis of H₂O₂ is preferred over the current process requiring high temperature, organic solvents, multi-step purification, and large-scale reactors. On-demand synthesis via electrochemistry would provide widespread availability, which is vital as water treatment and disinfection demands increase. CO₂RR converts CO₂ into many single- or multi-carbon products for use as fuels or building blocks. This includes CO, a component of Synthesis Gas essential for chemical production, and C₂H₄ or CH₂O, both needed for polymer applications. To bolster these reactions and develop greener technology, it is necessary to discover new materials that act as efficient and selective catalysts.

The experimental realization of materials with desired properties is expensive and time-consuming. One method to improve this is to expedite the synthesis of new materials. For this, scanning probe block-copolymer lithography (SPBCL) and polymer pen lithography (PPL) can be combined to make extremely large libraries of well-defined crystalline NPs. In SPBCL, aqueous inks comprised of metal salts and a polymer are deposited on a substrate using nanoscale tips, making 20-1000 nm diameter droplets. These act as nanoreactors for the metal precursors, which reduce and coalesce upon heating under H₂ to give single NPs composed of 1-7 metals depending on ink composition and with 2-50 nm diameters depending on droplet size (FIG. 9A). PPL is a parallel lithography technique where silicone pen arrays typically composed of 90,000 pens spaced every 50 μm are used. This array is repeatedly touched to the substrate to transfer ink, and each pen makes 2,500 droplets for a total of 225 million features. Prior to patterning, multiple inks are sprayed at different locations on the array to vary the metal composition and ink volume on the pens, allowing the positionally encoded deposition of 90,000 unique inks for the rational synthesis of a NP megalibrary with composition and size control (FIG. 9B). A record number of unique NPs are accessible within hours, but a major hurdle is screening properties of such a large number of materials, especially considering the challenges in detecting and differentiating signals when each of the 90,000 unique NPs has just 2,500 copies.

In biology, small molecule detection is essential for understanding cell signaling, metabolism, and disease. One powerful method is activity-based sensing (ABS), where a probe is synthesized to react specifically and irreversibly with an analyte to yield a fluorescent signal. ABS probes have been designed to detect various analytes at micromolar concentrations and micron spatial resolution in cells. An analogous approach could use such sensitive and selective probes to trap reaction products during catalysis and amplify the signal. Accordingly, NP megalibraries will be coated with ABS probes to screen catalysts in high throughput using fluorescence.

Catalyst performance is influenced by composition, size, shape, and support. For rapid electrocatalyst synthesis, drop-casting, ink-jet printing, or sputtering methods can be used to create libraries of amorphous or polycrystalline catalysts containing tens to thousands of catalyst compositions. Computational methods can also be used to explore larger materials libraries. With SPBCL/PPL synthesis developed by the Mirkin lab, even more of the design space can be explored synthetically because a larger number of crystalline particles is possible in each megalibrary, and a fluorescent strategy for characterizing each of the 90,000+ catalysts simultaneously will expedite the discovery of materials with certain desired properties.

A scanning droplet cell is commonly used to screen electrocatalysts by moving a millimeter-sized droplet of electrolyte across the library and measuring current responses at specified locations. This slow, sequential technique reveals relative activity with little or no insight into selectivity, but the small size is compatible with libraries on a single substrate. Another strategy uses pH-sensitive fluorophores for detection of catalyst activity, but it neglects product selectivity since many reactions induce a pH change. Furthermore, it has only been applied to libraries of up to a few hundred catalysts because imaging of the entire library during catalysis is required since the probes freely diffuse and the signal is reversible. Thus, the selective, irreversible, and confined probes used in the disclosure can vastly improve screening capabilities.

There is a need for improved methods that can rapidly synthesize large libraries of well-defined catalyst materials, and there is a bigger need for methods that can subsequently evaluate catalytic activity of all of the materials in the libraries with rapid speed. The combination of polymer pen lithography and polymer pen lithography solves the first challenge by allowing for the rapid synthesis of between 10 thousand and 200 million well-defined nanoparticle catalysts that have different compositions or sizes. Methods of the disclosure can potentially scale even larger. The polymer thin film coating on top of these catalyst megalibraries contain reactive molecular probes that allow for the entire library to be subjected to catalysis conditions simultaneously, and the products of catalysis are trapped by the probes and converted into a fluorescent signal that indicates catalyst selectivity and activity. The ability to synthesize large catalyst libraries and subsequently screen them simultaneously instead of serially will greatly facilitate catalyst discovery for a large range of technologies.

The probes and methods of the disclosure can allow for improved methods for rapidly discovering new catalysts that are more efficient and cost-effective than what is currently used in existing technologies or in developing technologies. This includes areas of energy, transportation, and petrochemicals where improved catalysts are needed for reactions such as water reduction to store energy in the form of hydrogen, oxygen reduction into water for use in fuel cells, oxygen reduction into hydrogen peroxide for use as an oxidant for synthesis or disinfection, carbon dioxide reduction into carbon monoxide for use in synthesis gas, and carbon dioxide reduction into ethylene for polymer synthesis. This can address needs in these specific reactions by identifying materials that are selective, active, stable, and inexpensive. The probes and methods of the disclosure can similarly be used for additional reactions where the products of interest can be trapped by rationally designed synthetic reactive fluorescent probes.

### BRIEF DESCRIPTION OF THE DRAWINGS

FIG. 1 is a schematic showing a general scheme for applying reactive molecular probes on top of a nanoparticle megalibrary. Fluorescence imaging provides spatially encoded catalytic performance information from the library.

FIG. 2 shows the reaction scheme for fluorescent sensing of H₂O₂ on top through the oxidation of boronic ester moieties on a fluorophore. This reactive probe, as well as a Cy5 internal standard dye, can be attached to short polystyrene groups to immobilize them on the library surface.

FIG. 3 shows a reaction scheme of fluorescent probes selective for sensing products of CO₂RR, the probes being synthesized with polystyrene moieties for application in thin film coatings on megalibraries for screening.

FIG. 4 is a darkfield optical microscopy image of the patterned nanoreactors (left) and fluorescence image after coating with the hydrogen peroxide sensitive polymer thin film and performing ORR (right).

FIG. 5 is a ratio-metric fluorescence image of the reactive probe fluorescence divided by the Cy5 dye fluorescence after ORR to visualize hydrogen peroxide synthesis.

FIG. 6 is a fluorescent imaging of hydrogen peroxide synthesis during ORR for a library of gold nanoparticles patterned with differing efficiencies resulting in a variety of gold nanoparticles.

FIG. 7 is a large area fluorescent imaging of ORR activity for hydrogen peroxide generation for an entire library of gold nanoparticles synthesized from 10,000 pens with 10 min of catalysis demonstrating the large scale of screening possible.

FIG. 8 is an image of a NP library synthesized using 100 pens each patterning 16 features. Coating with reactive fluorescent probes enables characterization of catalytic activity through visualization of reaction products.

FIG. 9A is a schematic showing SPBCL tip-directed synthesis of NPs with five representative metal precursors.

FIG. 9B is a schematic showing massively parallel patterning of NP precursors using PPL.

FIGS. 10A to 10D are reaction schemes showing (A) A boronate-masked fluorophore becomes fluorescent after reacting with H₂O₂. (B) Synthetic scheme of a tunable polymer-probe, or (C and D) modification of the molecular probe to introduce sufficient hydrophobicity for embedding into a thin film.

FIG. 11 is an optical microscopy image and corresponding fluorescence image, with the optical microscopy image on the left showing Au nanoreactors on an electrode substrate in 50×50 patterns made using 150 μm spaced pens and the subsequent fluorescence image on the right after electrolysis under O₂ with the fluorescent turn-on of the polymer-probe matching the locations of the patterned catalysts.

FIG. 12 is an image showing fluorescent detection of H₂O₂ after ORR using more closely spaced pens for patterning, showing spatial resolution with only 25 μm between pen patterns.

FIG. 13 is an image showing visualization of CO₂RR within a NP megalibrary. Three probes selective for CO, C₂H₄, or CH₂O can be used simultaneously in the polymer film due to their orthogonal reactivity and different excitation/emission wavelengths.

FIG. 14 is an image showing fluorescent visualization of CO formation after 3 min of CO₂RR on patterned Au nanoparticles.

FIG. 15 is an image showing fluorescent visualization of CO formation after CO₂RR with a library of AuCu catalysts containing a linear compositional gradient.

FIG. 16 is an image showing detection of C₂H₄ after CO₂RR performed with patterned Cu nanoparticles.

FIG. 17A is a schematic showing embedding ABS probes into individual nanoreactors post-NP formation.

FIG. 17B is an image of a library of 9 NP compositions each with 16 sizes that are individually coated with the cross-linked polymer-probes to detect products of ORR or CO₂RR catalysis at single NPs,

FIG. 18 is an image showing nanoreactor modification with the pH-sensing reactive probe, and changes in fluorescence intensity before and after ORR which causes a pH increase at the individual nanoparticles.

FIG. 19A is a schematic showing spatially controlled photocatalytic degradation of rhodamine B thin film using a method of the disclosure.

FIG. 19B is a fluorescence microscopy image of the rhodamine B thin film on top of patterned Au nanoparticles on TiO₂ after irradiation with visible light showing the spatially selective photocatalytic dye degradation reaction over the Au nanoparticle cocatalyst patterns.

FIG. 20A is an optical microscope image of a three-component Au—Pd—Cu megalibrary pattern of nanoreactors on a 2×2 cm² TiO₂ substrate.

FIG. 20B is an image showing the predicted composition gradients of Au—Pd—Cu across the 1.5×1.5 cm² patterned area of FIG. 20A.

FIG. 20C includes representative SEM images of trimetallic nanoparticles formed on TiO₂ after thermal annealing. Images were acquired in the nine equal sections of the patterned substrate. The bottom images are backscattered electron images due to the reduced Z-contrast between the substrate and Cu- and Pd-rich nanoparticles. Scale bars=1 μm.

FIG. 21 is an image showing photocatalyst screening of a Au—Pd—Cu megalibrary coated with rhodamine B film to quantitatively visualize relative activity. Fluorescence microscopy showed regions of fluorescence loss to different extends indicating the different activities for rhodamine B degradation. A region where the elemental rations were Au>Pd>Cu was identified as high performing photocatalysts.

FIG. 22 is a schematic image for synthesizing probe-functionalized thin films surrounding individual nanoparticles.

FIG. 23 show fluorescence images allowing for the visualization of an oxygen reduction reaction via changes in pH. At no applied potential in 0.1M NaClO₄ pH 6 electrolyte, the SNARF probe was primarily in closed form and a green color is seen. As potential was applied to drive oxygen reduction, which consumes protons, the local pH increased and the SNARF probe converted to the open form, showing a fluorescence change towards red that was more intense at stronger driving forces. Color not shown in the images.

FIG. 24A is a schematic of a ratio-metric probe for sensing hydrogen peroxide with a handle for nanoreactor functionalization and reaction scheme for making the probe.

FIG. 24B is a graph of fluorescence microscopy imaging of a 5 μm probe solution with 200 μM of added hydrogen peroxide showing a loss of fluorescence at 400 nm and increasing in fluorescence at 545 nm over time.

FIG. 25 shows the fluorescence P2VP nanoreactors labeled with the naphthalimide boronate probe with added 100 UM hydrogen peroxide showing a decrease in blue fluorescence and an increase in green fluorescence as the probe reacts with hydrogen peroxide (color not shown).

FIG. 26 are fluorescence images showing in-situ visualization of hydrogen peroxide formation during ORR with spatiotemporal control using probe-labeled nanoreactors containing Au nanoparticle catalysts (color now shown).

FIG. 27A is a fluorescence microscopy image of a rhodamine B coated Au—Pd—Cu megalibrary after 30 min of visible light irradiation. Scale bar=5 mm.

FIGS. 27B to 27E are magnified images of selected regions of the megalibrary of FIG. 27A, demonstrating the differences in fluorescence intensity that correlate with differences in relative catalytic activity. Scale bars=500 μm.

### DETAILED DESCRIPTION

Reactive molecular probes and polymers have been synthesized that can be applied as a thin film to the surface of a materials catalyst library to detect catalytic activity with an optical readout. Under electrocatalysis, photochemical, and/or thermal conditions, if a particular catalyst is successfully generating a product of interest, that product will react with the probe to generate an optical signal. For example, the optical signal can be a fluorescence signal. These surface-confined probes maintain high spatial resolution within the library, and the irreversible reactivity indicates catalyst selectivity while amplifying the low product concentration due to low catalyst density. The final optical signal intensity then correlates with catalyst turnover frequency. This detection method can work with libraries of nanoparticles containing potentially up to 10,000 different structural characteristics with rapid screening in under 10 minutes of catalysis. This method represents the most high-throughput method for catalyst screening to date.

A method for simultaneously testing a catalytic activity and/or selectivity of a plurality of catalyst can include coating a substrate having the plurality of catalysts with a polymer thin film that includes one or more reactive probes to form a coated substrate. Each reactive probe includes a signaling component that generates an optical signal upon reaction of the one or more reactive probes with the product of the target catalytic activity and/or selectivity, thereby allowing sensing and signaling of the product of the target catalytic activity and/or selectivity. The method then includes subjecting the coated substrate to catalysis conditions corresponding to the target catalytic activity and/or selectivity. Then the coated substrate is imaged for the optical signal. The presence of the optical signal in one or more regions of the coated substrate is indicative of catalysts of the plurality of catalysts in the one or more regions being active for the target catalytic activity and/or selectivity.

The methods of the disclosure can include forming a plurality of nanoreactors on the substrate and subjecting the substrate to conditions sufficient to form a catalyst within the nanoreactor from the nanoreactor precursor material. One or more reactive probes could be attached directly to each nanoreactor as opposed to coating the substrate with polymeric thin film having the one or more reactive probes therein. The plurality of nanoreactors can include a polymer. The polymer can be cross-linked after deposition and formation of the catalyst within the nanoreactors, but before attachment of the reactive probes. The nanoreactors can have a single reactive probe attached thereto or can have two or more probes attached thereto. The two or more probes can be capable of interacting with different ones of the target catalytic activity. The two or more probes can each include signaling components that generate distinct optical signals upon reaction of the reactive probe with the product of the target catalytic activity. For example, the signaling components can be fluorophores that fluoresce at different wavelength. This can allow for sensing and imaging of the different products of the target catalytic activity. This can be useful for a variety of reasons, including providing information on the selectivity of the catalyst for a given product.

A method of analyzing catalyst stability can include depositing a plurality of catalysts on a substrate, each catalyst comprising a metal ion. The substrate is then coated with a polymer thin film comprising one or more reactive probes to form a coated substrate. Each reactive probe comprising a signaling component that generates an optical signal upon reaction of the one or more reactive probes with the metal cation, thereby allowing sensing and signaling of catalyst degradation through metal cation loss. The coated substrate is then subjected to catalysis conditions and imaged for the optical signal. The presence of the optical signal in one or more regions of the coated substrate is indicative of loss of metal cations during catalysis and thereby catalyst instability.

A method of monitoring a catalysis reaction can include depositing a plurality of nanoreactors on a substrate and subjecting the nanoreactors to conditions sufficient to form a catalyst within each of the nanoreactors, each catalyst capable of generating target catalytic activity, wherein the target catalytic activity results in a change of pH around the nanoreactors. The method includes attaching one or more pH-sensitive signaling components to each of the plurality of nanoreactors, each pH-sensitive signaling component having an optical signal intensity that increases or decreases with the change in pH resulting from the target catalytic activity. The plurality of nanoreactors having the one or more pH-sensitive signaling components attached thereto is subjected to conditions corresponding to the target catalytic activity. The substrate is then image for the optical signal after subjecting the plurality of nanoreactors having pH-sensitive signaling components attached thereto to the catalysis conditions, wherein the target catalytic activity is characterized through the change in the optical signal intensity resulting from change in pH from the target catalytic activity. The signaling component can be for example a fluorophore comprising fluorescein.

Any of the method disclosed herein can include depositing the plurality of catalysts onto the substrate. For example, patterning methods, such scanning probe block copolymer lithography and/or polymer pen lithography can be used to pattern the plurality of catalyst on the substrate. Other patterning and deposition methods as known in the art can be used.

In any of the methods herein, the catalyst can include or be one or more of Au, Ag, Pt, Pd, Ni, Co, and Sn. In the methods of sensing catalytic stability, the catalysts can include cations of one or more of Au, Ag, Pt, Pd, Ni, Co, and Sn.

In any of the methods herein, the plurality of catalysts can have different types of catalyst. That is catalysts that differ in one or more of composition, catalyst concentration, for example, metal cation concentration, geometry, and size.

The reactive probe can interact reversible or irreversibly with the product of the target catalytic activity and/or selectivity.

The target catalytic activity can result in multiple products. The polymer thin film can have different reactive probes, each capable of detecting different ones of the products. Alternatively, the polymer thin film can have a single reactive probe type, capable of reacting with only a single product to thereby evaluate selectivity of the catalyst for a given product of the catalytic activity. Any number of probes for reacting with all or any substrate of products of the target catalytic activity can be included in the polymer thin film.

The signaling component of the reactive probes can be, for example, a fluorophore. The fluorophore can generate a fluorescence signal or trigger a loss of fluorescence signal upon reaction of the reactive probes with the product of the target catalytic activity and/or selectivity. For example, the reactive probes can include fluorophores attached to boronate esters. For such reactive probes, the target catalytic activity can be an oxygen reduction reaction for which H₂O₂ is the product, and upon reaction of the reactive probes with H₂O₂, the boronate ester oxidizes allowing the fluorophore to fluoresce. Other fluorescent or colorimetric dye probes can be used. For example, rhodamine B, methylene blue, rhodamine 6G, methyl orange, malachite green, and phenol red can be used.

For example, the reactive probes can be attached to an alkyl boronate to enable facile nanoreactor labeling. Nanoreactor compositions containing poly(2-vinylpyridine) (P2VP) include nucleophilic pyridine groups that can act as site for probe attachment. For example, a pH sensitive reactive probe can be prepared by modifying a pH sensitive fluorescence dye with an alkyl bromide functional group. This can allow for covalent attachment to patterned nanoreactors. The pH-sensitive dye can be, for example, seminapthardodaflur (SNARF). Other suitable pH-sensitive probes can include fluorescein, Oregon green, 2′,7′-Bis-(2-Carboxyethyl)-5-(and-6)-Carboxyfluorescein (BCECF), pHrodo, lysoSensor, 6,8-dihydroxypyrene-1,3-disulfonic acid.

For example, a reaction product sensing reactive probe can also be modified with an alkyl bromide for attachment to the nanoreactors. For example, a naphthalimide fluorophore can be modified with an alkyl bromide functional group for nanoreactor attachment. Naphthalimide includes a boronate group that is known to react selectively with hydrogen peroxide to induce fluorescence changes. When used in methods of the disclosure, such a reactive probe can be used to quantify the selectivity during an ORR reaction towards water or hydrogen peroxide.

Example methods of the disclosure are demonstrated and discussed herein with reference to fluorophores as the signaling component by way of example. However, it should be understood that other signaling components capable of generating an optical signal upon reaction with the target of the catalytic activity and/or selectivity can be used. For example, the signaling component can include molecules that become fluorescent and increase in fluorescence intensity, fluorophores that become non-fluorescent and decrease in fluorescence intensity, fluorophores that change fluorescence wavelength(s), molecules that become colored or change color through changes in visible light absorption, molecules that change absorption of infrared light, and molecules that form, aggregate, assemble, or polymerize into a visibly macroscopic product. These optical signals can be detected using microscopy or spectroscopy of fluorescence, absorption, or scattering of ultraviolet, visible, or infrared light.

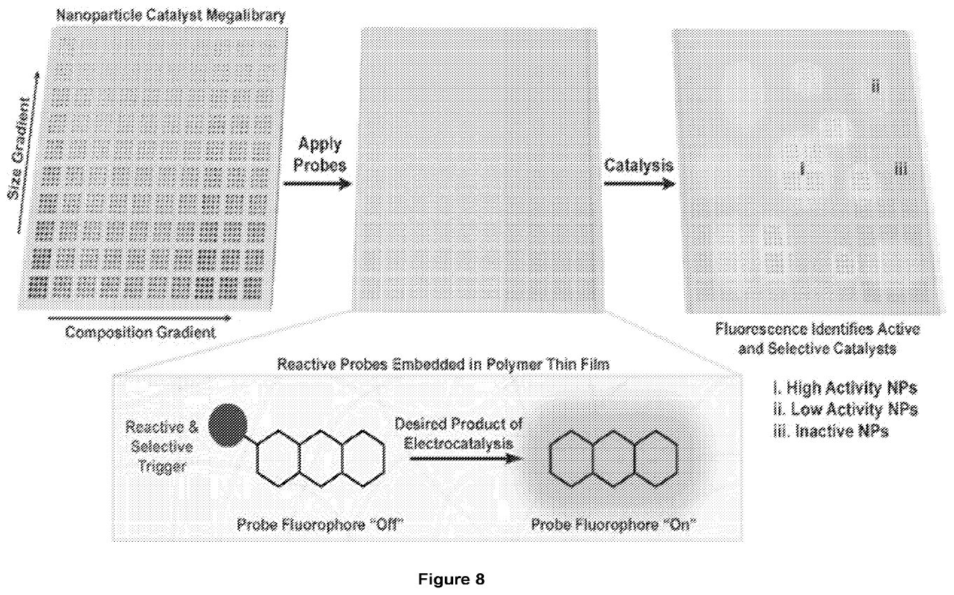

Methods of the disclosure can provide an optical detection technique for high throughput analysis of activity and product formation simultaneously within a “megalibrary” containing millions of rationally designed nanoparticle (NP) catalysts. Reactive probes are confined at the megalibrary surface, and in regions where a catalyst is generating product, the probe will react and become fluorescent. Thus, in a single megalibrary experiment, a spatially encoded fluorescence signal locates active catalysts, the inherent reactivity of the probes indicates catalyst selectivity, and the optical signal intensity correlates with the amount of product generated and thus catalyst activity (FIG. 8).

Any type of catalytic activity can be detected and signaled using the method of the disclosure. For example, the target catalytic activity can be CO₂ reduction. The products to which the reactive probes react can be any one or more of CO, HCO₂H, CH₂O, CH₃OH, CH₄, C₂H₄, C₂H₅OH, and CH₃CO₂H. Other applications include but are not limited to the following. Hydrogen peroxide formation can be detected as the product of electrochemical/photochemical oxygen reduction catalysis. Carbon monoxide can be detected as the product of carbon dioxide reduction. Ethylene or other alkene formation products can be detected as the product of carbon dioxide reduction to ethylene or alkene synthesis from Fischer-Tropsch catalysis. Formaldehyde formation can be detected from the reduction of carbon dioxide to formaldehyde or methanol oxidation to formaldehyde. Acetic acid or other carboxylic acid formation can be detected as the product of carbon dioxide reduction to acetic acid or alcohol oxidation to carboxylic acids. Oxygen formation can be detected as the product of water oxidation/oxygen evolution reaction catalysis. Aldehyde or ketone formation can be detected as the product of alcohol oxidation to aldehydes or ketones or hydroformylation catalysis or aldehyde synthesis from alkenes, CO, and H₂. Carbon dioxide formation can be detected as the product of alcohol oxidation to CO₂ for fuel cell catalysis or formic acid oxidation for CO₂ for fuel cell catalysis. Amine formation can be detected as the product of nitrate reduction to ammonia or hydroxylamine or nitrogen reduction to ammonia. Metal ions can be sense as a product of catalyst leaching/decomposition.

Target catalytic activity can be one or more of photocatalysis, electrocatalysis, and/or thermal catalysis. For example, the methods of the disclosure can be for identifying catalysts for photodegradation of organic pollutants.

The reactive probes can be chosen based on the chemical nature of the desired product to sensed. Chemospecific molecular reactivity or molecular binding/recognition can be used for specific analyte sensing. For example, products possessing functional groups with known reactivity or metal binding can be sensed with reactive probes that are designed to have complementary reactivity and/or binding. Common reaction classes used for the design of reactive probes for analyte sensing include oxidative reactions, reductive reactions, nucleophilic addition or substitution, condensations, rearrangements, ligand displacement, demetallation, protonolysis, hydrolysis, metathesis, or bond cleavage. Upon reaction between analyte and probe through one of these chosen pathways, the probe will yield the desired optical signal. The diversity of selective reactivity and binding allows for selection of reactive probes that can sense products or analytes of interest in various applications, including different types of catalytic reactions or materials stability, among others.

The optical signal can be imaged or otherwise analyzed for signal intensity. Signal intensity can be indicative, for example, of catalyst turnover. For example, a fluorescence intensity can be analyzed in the methods of the disclosure.

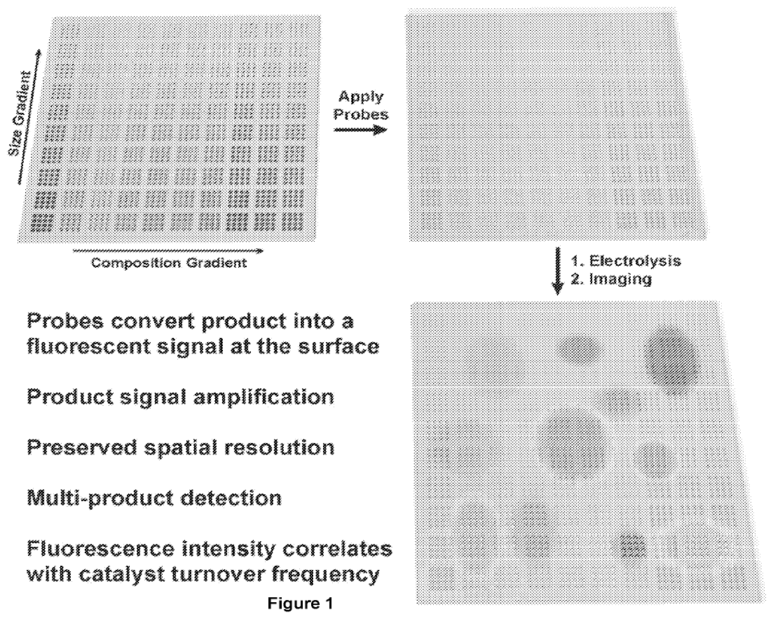

Disclosed herein is the synthesis of reactive molecular probes that are covalently embedded into polymer thin films to create a responsive material. This responsive film is then applied on top of a library containing large number of catalysts with different compositions or sizes. Subjecting this to catalytic conditions then reveals an optical readout in which the presence of a fluorescent signal locates regions in the library containing active catalyst, the inherent reactivity of the probe leading to fluorescence indicates catalyst selectivity, and the fluorescence intensity correlates with the catalyst turnover frequency (FIG. 1).

The polymer thin film can include a polymeric backbone and one or more reactive probes attached to the polymeric backbone such that the reactive probes are insoluble during catalysis.

The probes and methods of the disclosure have been demonstrated to allow for the rapid screening characterization of gold nanoparticles for selective hydrogen peroxide synthesis during ORR. The probes and methods of the disclosure can also be used with compositional nanoparticle megalibraries using multi-component nanoparticles to identify improved nanoparticle compositions. Additionally, CO₂RR can be screened using the synthesized reactive polymer-probes, and additional catalytic reactions will be explored for potential rapid screening.

The probes and methods of the disclosure can allow for performance evaluation of a greater number of different catalyst materials and in a shorter period of time than existing technologies. Polymer pen lithography and scanning probe block copolymer lithography enable the rapid synthesis of thousands to millions and potentially billions of different materials on a single substrate. The reactive probes are attached to polymers to make them insoluble during catalysis and to prevent movement on the library surface, which preserves spatial resolution of the probes detecting active catalysts. The reactive probes can react irreversibly with the product(s) of interest, which (i) allows for product accumulation over extended catalysis to amplify the signal from low product concentration and facilitating detection and (ii) maintains the fluorescent signal and allows for imaging after extended catalysis instead of requiring imaging during catalysis. The probes can be reactive specifically to a single product of interest, so this inherent reactivity for detection also indicates the catalyst selectivity for catalytic reactions that generate multiple products. The insolubility, confined location, and irreversible reactivity of the probes within the polymer thin film all allow for the simultaneous evaluation of catalytic activity of the entire library of materials as opposed to serial screening methods. The reactive probes are readily interchanged to analyze different catalytic reactions and detect different products of interest giving this platform broad utility. Multiple reactive probes can be introduced to the thin film coating to allow for detection of multiple products of interest simultaneously.

The probes and methods of the disclosure can be used in a variety of application, such as, but not limited to: discovery of catalyst materials for oxygen reduction into hydrogen peroxide, an important industrial oxidant; discovery of catalyst materials for fuel cells, such as oxygen reduction into water; discovery of catalyst materials for carbon dioxide reduction into fuels or chemical building blocks, such as carbon monoxide, formaldehyde, ethanol, and ethylene; discovery of catalyst materials for nitrogen or nitrogen oxides reduction into ammonia; discovery of catalyst materials for hydrogen synthesis from water; discovery of catalyst materials for water splitting reactions; discovery of corrosion resistant catalysts and materials; discovery of catalyst materials for polymer recycling or decomposition; and discovery of catalyst materials for dehydrogenation reactions.

The methods of the disclosure can be used to form a nanoparticle library of Au—Pd composition and size, which are coated with probe, and subjected to catalysis. Imaging can be used to show a variation in fluorescence intensity with the region of highest intensity identifying NPs that generated the most target catalytic activity, such as H₂O₂ production. The composition of these NPs can be determined from the ink spray profile, and electron microscopy can be used to further characterize them. A second generation megalibrary can then be synthesized where the identified Au—Pd ratio is held constant, and a gradient of Sn is doped in making a AuPd—Sn library. Alternatively, ternary Au—Pd—Sn megalibraries can then be directly synthesized by introducing more spray steps applying ink to the pen array to show that more complex library synthesis can further expedite materials discovery. Megalibraries of single NPs can be made by SPBCL/PPL using Au, Ag, Cu, Pt, Pd, Ni, Co, and Sn, for example. Several Pt- and Hg-based alloys have shown H₂O₂ selectivity, so the screening may be used to discover catalysts that lower costs of noble-metal alloys and avoid toxicity.

### EXAMPLES

### Example 1

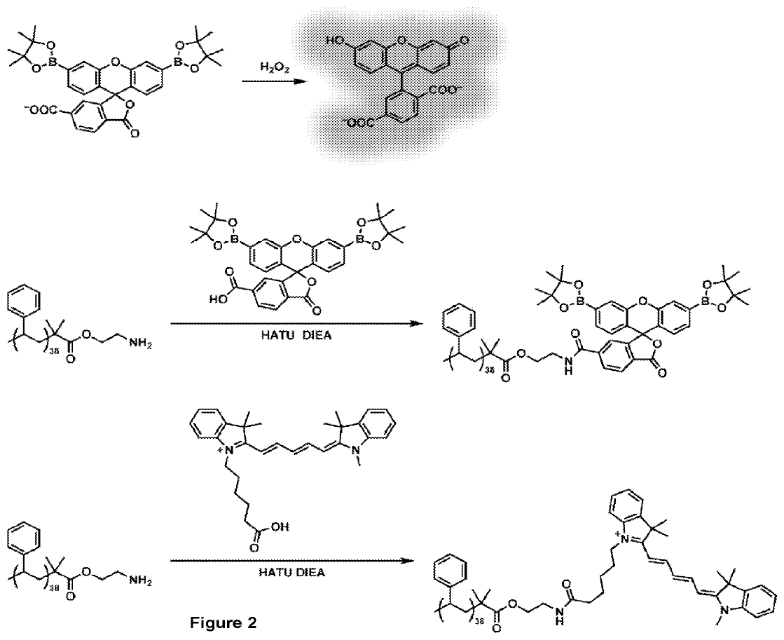

The probes of the disclosure have been used to identify active catalysts for the generation of hydrogen peroxide during the oxygen reduction reaction (ORR). A reactive probe was synthesized by installing boronic ester functional groups onto a fluorophore scaffold. This makes the fluorophore non-fluorescent, and after selective reaction with hydrogen peroxide, the boronic esters are oxidized and the fluorophore is generated (FIG. 2). To embed this probe into a polymer thin film that prevents dissolution and maintains spatial resolution within the film, short polystyrene chains were covalently attached to the probe (FIG. 2). Briefly, to a solution of amino-terminated polystyrene (molecular weight=4,500) in N,N-dimethylformamide was added 5 equiv. of probe containing a carboxylic acid functional group. Then 10 equiv. of hexafluorophosphate azabenzotriazole tetramethyl uranium (HATU) and 15 equiv. of N,N-diisopropylethylamine (DIEA) were added. The reaction mixture was stirred overnight at room temperature, and then poured into water. The precipitate was collected by vacuum filtration, washed with water and methanol, and then dried in vacuo.

A similar synthesis was used to append a polystyrene chain onto a Cy5 dye, which act as an internal standard unresponsive to the catalysis conditions to minimized variations in fluorescence intensity due to variations in film thickness and excitation light intensities (FIG. 2).

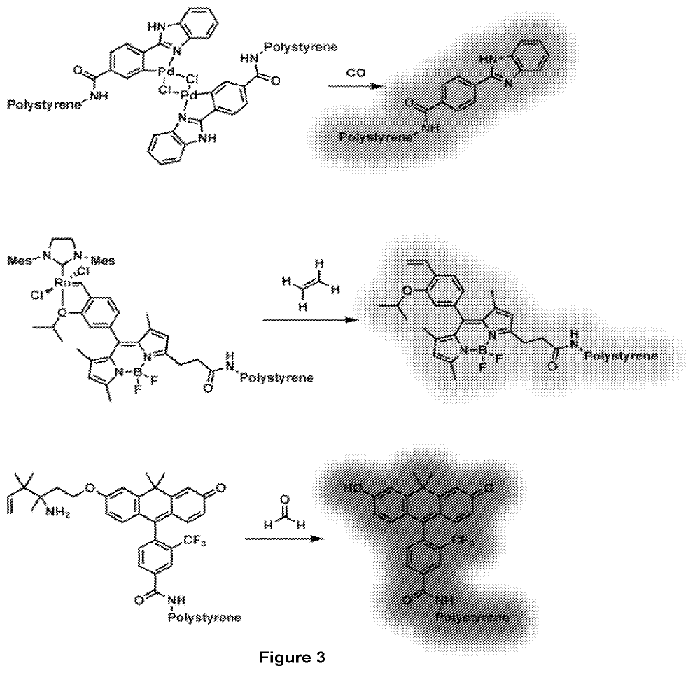

To begin screening CO₂RR catalysts, probes specific for sensing carbon monoxide, formaldehyde, and ethylene were synthesized with different fluorophore scaffolds such that they will fluoresce at different wavelengths, allowing for simultaneous multi-color detection. As above, polystyrene moieties were then covalently attached through amide bond formation to provide insoluble thin film components that were selectively responsive to products of interest (FIG. 3).

A combination of polymer pen lithography (PPL) and scanning probe block copolymer lithography (SPBCL) was used for synthesizing libraries containing large numbers of well-defined nanoparticle catalysts. Nanoscale pen tips were used to transfer droplets of polymer and nanoparticle precursors onto a glassy carbon electrode substrate in precise positional patterns. Thermal treatment converted these droplets into single nanoparticles with pre-determined composition and size based on the preparation of the pen tips and patterning procedure. This method generated megalibraries of materials consisting of hundreds of millions of individual nanoparticles with tens of thousands to millions of distinctly different compositions or sizes.

The reactive probes and catalyst library were then interfaced with each other. First, a 1.7 mM solution of polymer-probe and of internal standard dye was made in N,N-dimethylformamide, and then an equal volume of an ethanol solution containing 5% of an amphiphilic polymer composed of styrene and imidazolium moieties was added. This amphiphilic polymer acted as a binder for the thin film and makes the film more hydrophilic to allow for diffusion of electrolyte without dissolution of the film. The mixture was then spin-coated onto a megalibrary substrate at 3000 rpm for 1 min and subsequently dried in air.

The megalibrary with attached responsive film was then subjected to catalysis conditions. For ORR, a 0.1 M Na₂SO₄ pH 7 electrolyte saturated with oxygen was used. The library was used as the working electrode and is submerged in the electrolyte along with a Pt coil counter electrode and a Ag/AgCl reference electrode. A BASi Epsilon potentiostat was then used to apply a potential between −100 mV and −600 mV vs Ag/AgCl for 1-10 min. The megalibrary with thin film coating was then removed, submerged in purified water several times to rinse away residual electrolyte, and then dried under a stream of N₂.

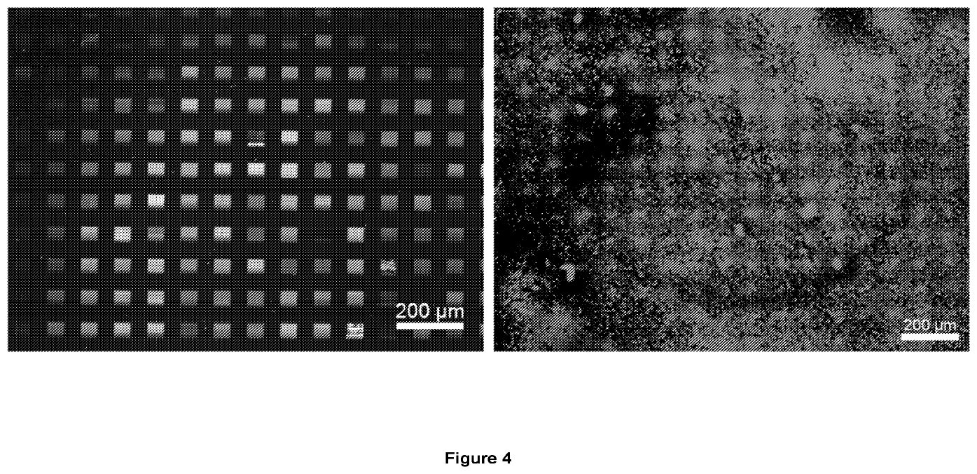

A fluorescence microscope was used to identify regions of the megalibrary that resulted in a turn-on fluorescence response, indicating active catalyst. In the first example, a pattern of gold nanoparticles in 50×50 arrays with 1 μm spacing, and with each array spaced 50 μm apart was used. After applying-600 mV vs. Ag/AgCl for 3 min, the electrode was imaged with 450-490 nm excitation. FIG. 4 identifies locations on the electrode where increased fluorescence corresponded to the nanoparticle pattern geometry, suggesting that the gold nanoparticles acted as ORR catalysts to generate detectable H₂O₂ that was trapped by the confined probes and transformed into a fluorescent signal.

### Example 2

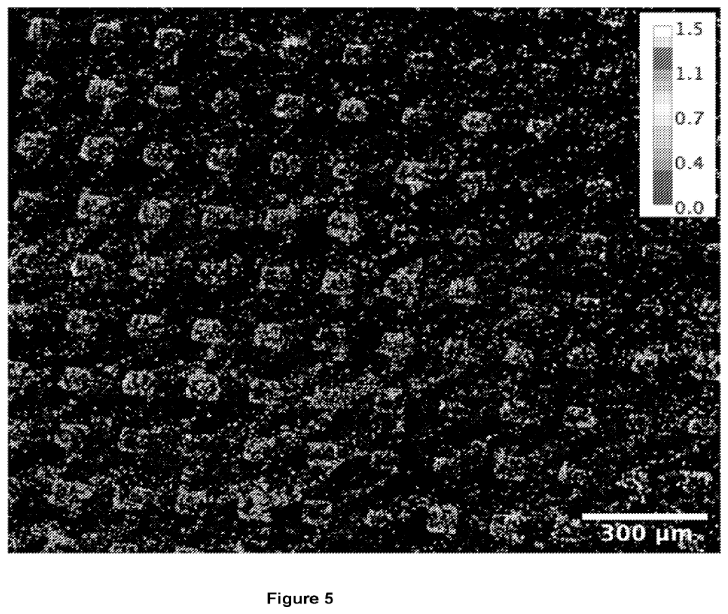

In the second example, 50×50 patterns of gold nanoparticles with 1 μm spacing was used with each of these arrays spaced 100 μm apart. After applying-300 mV vs. Ag/AgCl for 3 min the electrode was imaged by fluorescence microscopy with both 450-490 nm and 538-562 nm excitation to excite the reacted probe and the internal standard, respectively. The ratio of these two images was then taken (FIG. 5). Again, patterns of increased fluorescence were observed that correspond with the particle pattern. In this case, a ratiometric analysis approach allows for more accurate comparison between experiments because it can account for differences in spin coating efficacy, sample thickness, and excitation/emission light intensities.

### Example 3

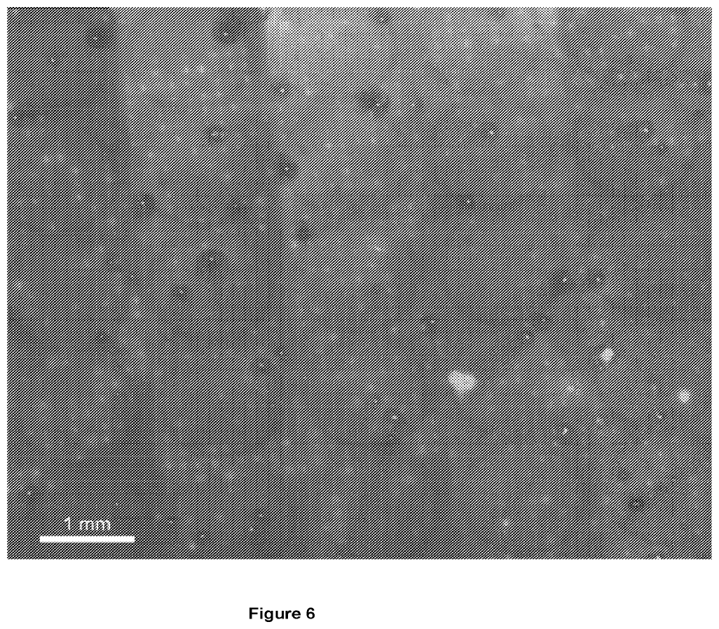

In the third example, 50×50 patterns of gold nanoparticles with 1 μm spacing was used again with each of these arrays spaced 100 μm apart. In this example, the patterning efficiency was lowered such that not all pens resulted in patterned particles, and in some regions adjacent nanoreactors combined resulting in larger amorphous particle formation. After applying-300 mV vs. Ag/AgCl for 1 min, the electrode was imaged with 450-490 nm excitation. FIG. 6 shows increased fluorescence signal corresponding to the intended pattern. Areas of the pattern without fluorescence corresponded to pens that did not pattern, and regions of the pattern with large areas of greater fluorescent intensity corresponded to regions where adjacent nanoreactors mixed. This experiment demonstrated that screening can be used to distinguish between different particles with the same composition and that it can be performed in as little as 1 min of catalysis.

### Example 4

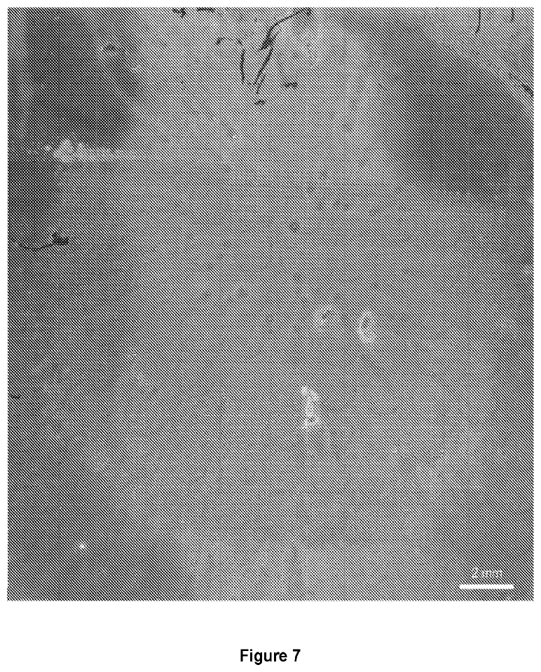

In the fourth example, the same conditions as the third example were used, but the potential was applied for 10 min and the entire library was imaged by fluorescence microscopy by taking 70 images and stitching them together. FIG. 7 shows the fluorescent detection of hydrogen peroxide across the entire library of gold nanoparticles. The patterning efficiency of the pens varied throughout, so the exact size and morphology of the gold nanoparticles changed throughout. The screening method can differentiate between these differences as seen by the differences in fluorescence intensity. This image shows characterization of a library made from at least 10,000 pen tips after just 10 minutes of catalysis, highlighting the potential value in a new rapid and simultaneous screening technique.

### Example 5

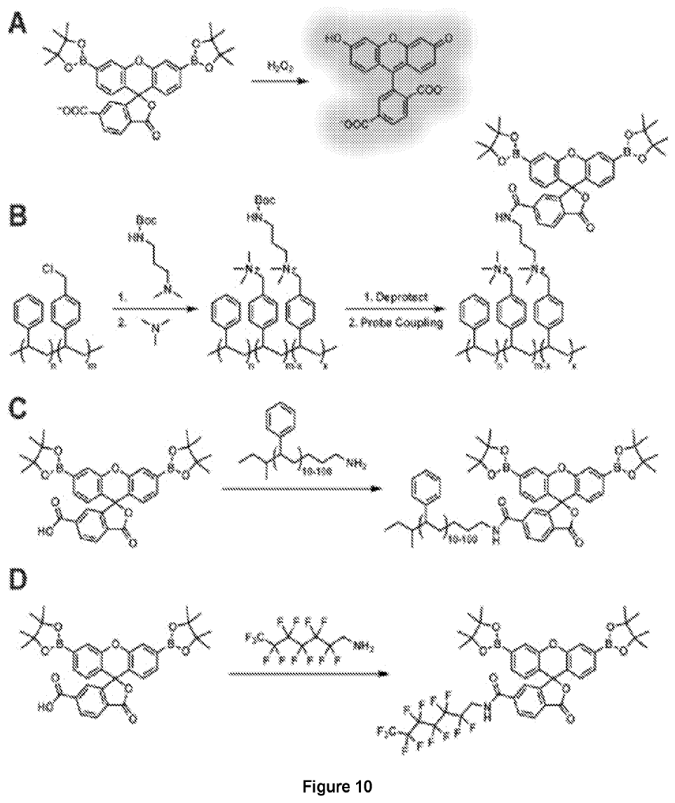

Screening NP libraries for selective O₂ reduction to H₂O₂. Selective H₂O₂-generating catalysts for ORR was identified using H₂O₂ ABS probes. Fluorophores were be masked by boronate esters, which upon oxidation by H₂O₂ become fluorescent (FIG. 10A). Accordingly, such probes can be applied onto a NP megalibrary to detect H₂O₂ during ORR. An amphiphilic polymer was coated on the electrode to make a film that is water-insoluble but allows diffusion of substrates and products, and the probe was bound in a way that prevented dissolution/diffusion and maintains spatial resolution.

The first step was embedding the probe into thin film coatings. In one approach, the probes were covalently attached to an amphiphilic polymer (FIG. 10B). This permitted full customization of the polymer length, hydrophobicity, and probe loading, but it required a multi-step synthesis that hinders scalability. FIG. 10C shows an alternative method appending a short poly(styrene) chain to make the probe sufficiently hydrophobic and then mixing this with a separate amphiphilic polymer such as Sustainion or Nafion, common catalyst binders. This simplified the synthesis to a single step, making it more accessible to other probes and expediting screening different polymers and probe loading. Instead of poly(styrene), smaller molecular modifiers with sufficient hydrophobicity can be used, such as perfluoroalkanes (FIG. 10D). To ensure the probe was compatible with electrocatalysis, the probes were tested applying no potential or applying potential in the absence of O₂; in each case, the probe should be unresponsive. Then, the applied potential was screened under ORR conditions. Afterwards, the entire electrode was imaged to map fluorescence intensity, and thus catalyst activity.

Advantageously, ABS probes react irreversibly with H₂O₂, compensating for the low NP density (1 NP/μm²) by amplifying product generation over longer reaction times and preserving spatial resolution and intensity until imaging. A limitation is diffusion of product away from where it was generated before reacting with probe, but the large excess of probe in the film compared to the product concentration favored rapid trapping. Product generation in the ˜150 nm thick film also resulted in a high effective concentration that accelerated trapping. A second fluorophore can be incorporated that emits at a different wavelength and is unresponsive to H₂O₂ to serve as an internal standard to improve quantification. After multiple library generations, the NP size and composition were reproduced on milligram scale to verify performance. It is important to address any effects of a thin film. Recent work using molecular coatings to influence electrocatalysts has shown pronounced sensitivity to the molecular environment. Without intending to be bound by theory, it is believed that since the polymer-probe films have minimal coordinating groups or hydrogen bond donors, the primary effects are expected to be due to mass transport changes, which should be equal throughout the library and therefore still allow relative comparison of catalyst performance. After catalyst identification, traditional characterization techniques were performed with and without the film.

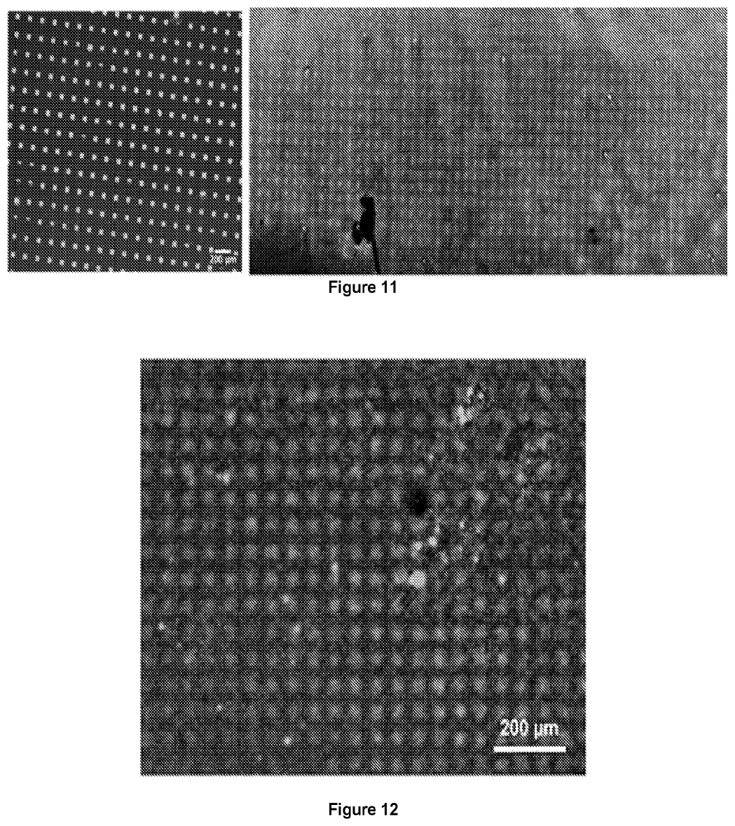

Electrocatalyst testing began with a uniform pattern of Au NPs synthesized on glassy carbon. The polymer-probe coating solution was spin coated on top of this electrode. After applying a potential in O₂-saturated electrolyte to drive ORR, the electrode will be imaged. H₂O₂ generation by the NPs created a uniform fluorescent response in a geometry matching the NP pattern. FIG. 11 shows an optical microscope pattern of uniform Au nanoreactors in a 50×50 pattern with 1 μm spacing made using 150 μm spaced pens, so that square patterns made by individual pens were spaced 100 μm apart. After applying the polymer-probe coating and submerging in O₂ saturated 0.1 M Na₂SO₄ electrolyte, a potential of 200 mV vs RHE was applied for 10 min. The electrode was then imaged with a fluorescence microscope revealing a square pattern of increased fluorescence that matches the pattern of nanoreactors. Thus, the polymer-probe coating selectively reacted with H₂O₂ formed during electrolysis to generate the fluorophore, which was spatially isolated, allowing visualization of catalysis. Subsequently, a denser pattern of uniform Au nanoreactors was made where 50 μm spaced pens patterned 25×25 nanoreactors with 1 μm spacing, giving a 25 μm gap between adjacent pen patterns. Coating with the polymer-probe and performing the same electrolysis resulted in the fluorescence shown in FIG. 12. Again, the fluorescence observed matched the patterned nanoreactors. This shows that the catalyst separation can be decreased, while maintaining sufficient spatial resolution for visualizing catalysis. These results demonstrate that the method of the disclosure for trapping products at the catalyst surface and converting them into an optical response is viable, and can be used to compare relative catalyst activities

### Example 6

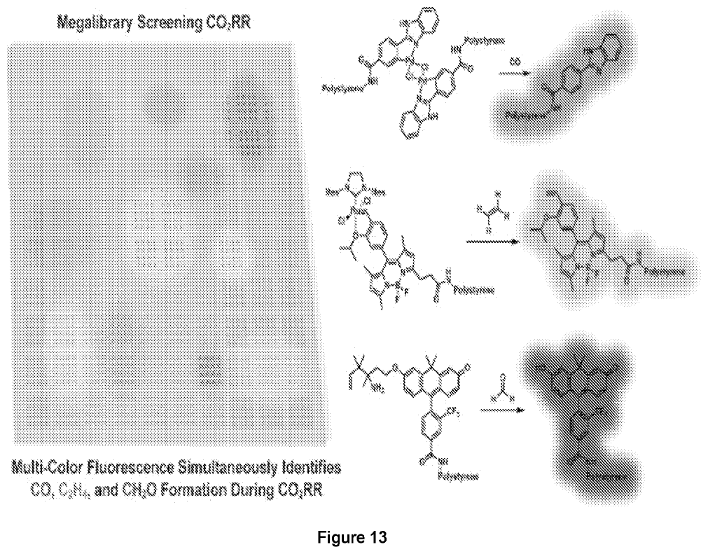

Multi-color detection for screening CO₂ reduction. More complex reactions CO₂RR, where the products include CO, HCO₂H, CH₂O, CH₃OH, CH₄, C₂H₄, C₂H₅OH, and CH₃CO₂H, among others, are complicated to assess using high throughput screening methods that typically cannot identify products. However, the ABS strategy can be used with several different probes incorporated into the polymer film for multi-channel analyte detection. For example, certain ABS probes that rely on Pd, Ru, or homoallylamine reactive groups become fluorescent after exposure to CO, C₂H₄, or CH₂O, respectively. These reactive triggers can readily be appended onto different fluorophores to differentiate the emission color (FIG. 13). With each probe coating the library, the selectivity and activity can be determined for three CO₂RR products simultaneously by measuring the fluorescence of the individually excited fluorophores. Any effects due to potential contamination by the Pd²⁺- and Ru²⁺-containing probes will be intensely surveyed.

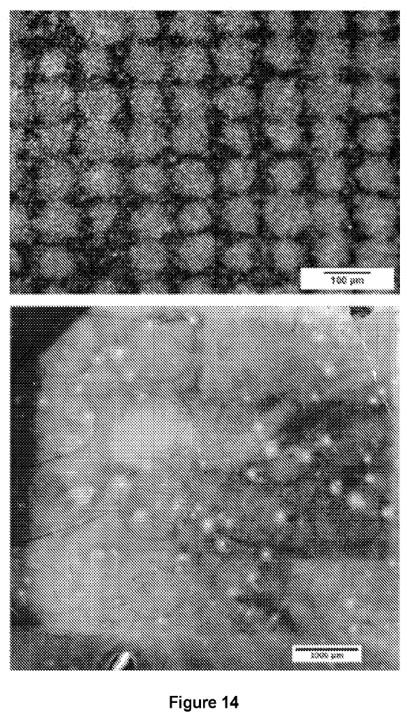

A pattern of Au nanoparticles was coated with a CO-sensitive polymer-probe. Electrolysis was performed in CO₂ saturated 0.5 M KHCO₃ at −1.4 V vs RHE for 3 min. Fluorescence imaging in FIG. 14 shows the turn-on fluorescence response above the patterned catalysts as CO₂ is reduced to CO. Imaging the entire 1 cm² electrode shows that the fluorescence response occurs over large areas and that changed in fluorescence intensity are observed indicating changes in the amount of CO generation. In this experiment, patterning challenges resulted in areas containing higher Au concentrations than in others, which would increase the catalysis in those areas. Thus, it can be seen how fluorescence sensing can gauge relative catalyst turnover, which will be needed when screening megalibraries of catalysts to identify the best performer.

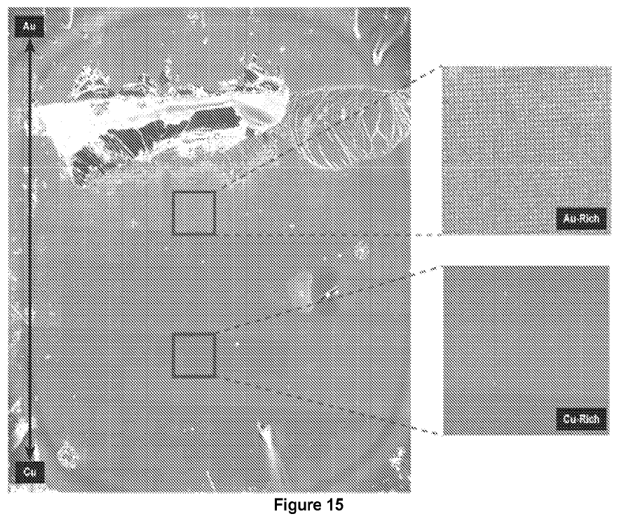

An initial megalibrary screening experiment was performed by first synthesizing a liner gradient of Au—Cu nanoparticles. Spray guns were used to apply ink concentration gradients onto the pen arrays and subsequently pattern nanoreactors that vary the Au and Cu content in a controlled manner. For CO₂RR into CO, Au and Au₃Cu nanoparticles are known to have significantly higher turnover than AuCu, AuCu₃, and Cu nanoparticles. After the library was coated with the CO-sensitive polymer-probe and electrolyzed, this catalyst turnover trend was visualized in the fluorescence response. FIG. 15 shows that at the top of the library where Au-rich nanoparticles were located, a fluorescence turn-on was observed in a pattern that matches the patterned catalyst. This side of the library also exhibited substantial cracking and delamination of the glassy carbon substrate due to the increased current from catalysis. Moving down the Au—Cu gradient towards the Cu-rich region, the fluorescence decreased and disappeared. This verified that fluorescence intensity can be used to screen a library of catalysts for relative activity. If each pen patterned nanoreactors with a distinct Au—Cu ratio in this single linear gradient, a total of 300 catalyst compositions were screened in a single 5 min experiment.

Catalysts that selectively produce C₂H₄ during CO₂RR are particularly desired because of the vast utility of C₂H₄ in polymerizations and synthesis. Currently, only Cu-based catalysts are known to generate C₂H₄ and other products containing carbon-carbon bonds. The C₂H₄ selectivity of a range of Cu alloy libraries was screened. Most precedent has focused on nanostructured Cu or bimetallic Cu alloys; the methods of the disclosure can easily expand the number of elements (up to 8) in multi-component NP megalibraries. Additionally, many multi-component NPs are known to phase segregate depending on atomic composition.⁵⁷ Thus, these compositional megalibraries can be used to explore the influence of rationally synthesized interfaces and heterostructures. Further, methods of the disclosure can allow for the rapid synthesis of diverse megalibraries to potentially discover non-Cu-based catalysts capable of CO₂RR into C₂H₄.

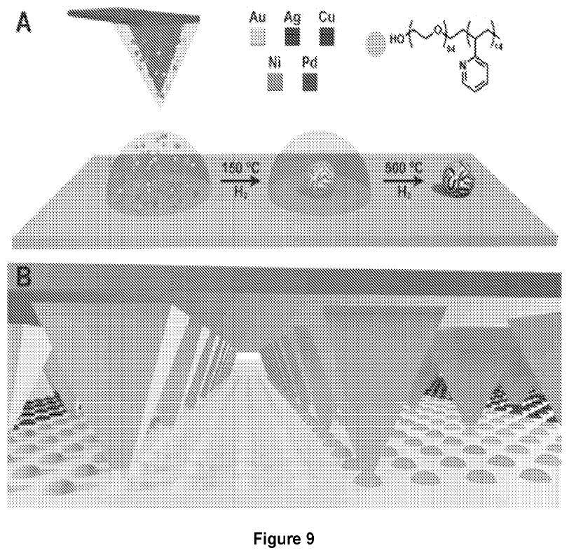

Fluorescent detection of C₂H₄ generation during catalysis was demonstrated by patterning Cu nanoparticles and coating them with a C₂H₄-sensitive polymer-probe. FIG. 9 again shows that this visualization technique is viable after <5 min of electrolysis under CO₂. Overall, the reactive probe can be readily exchanged depending on which product of interest one wants to observe. Incorporating all three probes in FIG. 13 can enable discovery of selective CO and CH₂O catalysts in addition to selective C₂H₄ catalysts simultaneously due to their different colors. These three products represent distinct pathways in the complex multi-electron reduction of CO₂. Identifying selectivity trends over large libraries will lead to better understanding of how to favor 2-electron reduction, >2-electron reduction, and C—C coupling pathways.

### Example 7

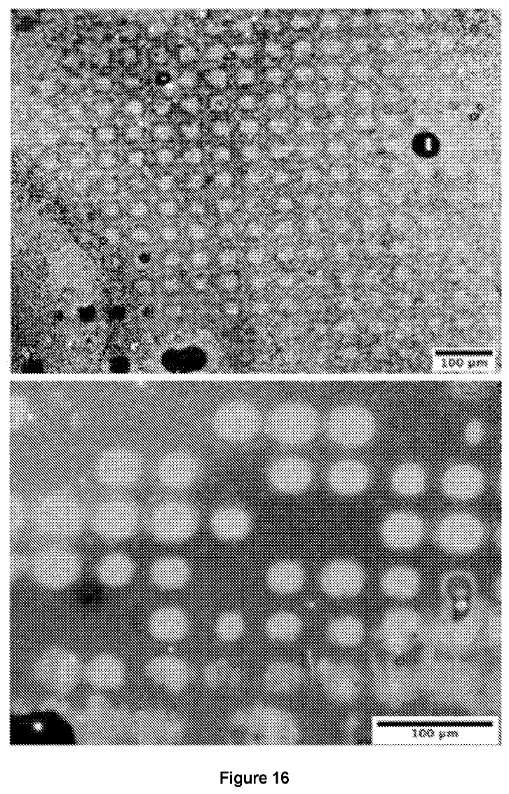

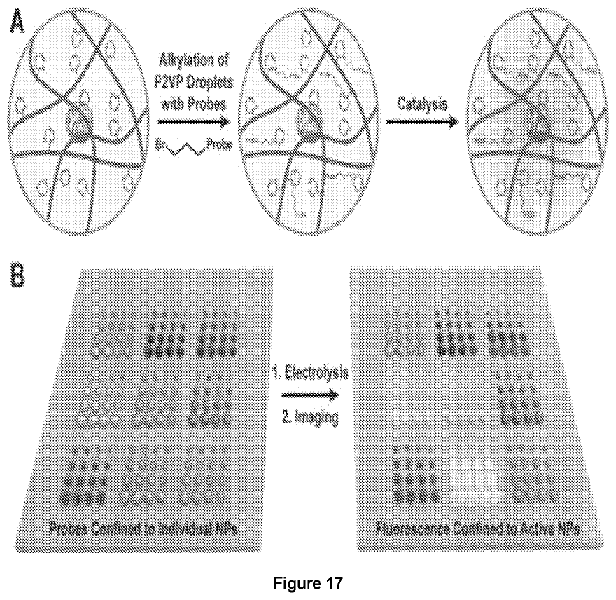

Monitoring catalytic activity with single-NP resolution. In SPBCL, the polymer droplets served as nanoreactors and were removed after NP formation (FIG. 16A). Alternatively, this polymer can be conserved around each NP and used as a scaffold to append ABS probes were used to give single NP resolution for product detection. The nanoreactor contains blocks of poly(2-vinylpyridine), P2VP, which offers a functionalizable handle through N-alkylation; however, the nanoreactor will readily dissolve in solvents used for functionalization or catalysis. To circumvent this, the polymer was be cross-linked after NP formation by UV irradiation to create an insoluble, porous matrix around each NP. ABS probes with an alkyl bromide moiety were then covalently attached (FIG. 17A). Thus, the probes sensed products produced by individual NPs, and the signal-to-noise ratio was enhanced since the probes were present in non-patterned areas. With single NP resolution, the PPL strategy can be modified such that the ink spraying dictates the NP compositional gradient while the pen-surface contact time dictates the NP size gradient. So, instead of the 90,000 pens each patterning 2,500 identical NPs, the size gradient will be included in those 2,500 features since the single NP resolution allows them to be distinguished (FIG. 17B). Methods of the disclosure can make it possible to synthesize and screen hundreds-of-millions of distinct NP catalysts in a single experiment.

In SPBCL, each ˜500 nm nanoreactor contained a single ˜20 nm NP. Current, conventional strategies for monitoring single NP catalysis require expensive instrumentation or limited analysis of reactants and products. With methods of the disclosure, both the NPs and the probes monitoring catalysis are highly customizable and easily observed. Greatly facilitating such single NP experimentation would aid in better understanding of mechanistic steps and further broaden this proposed work beyond screening.

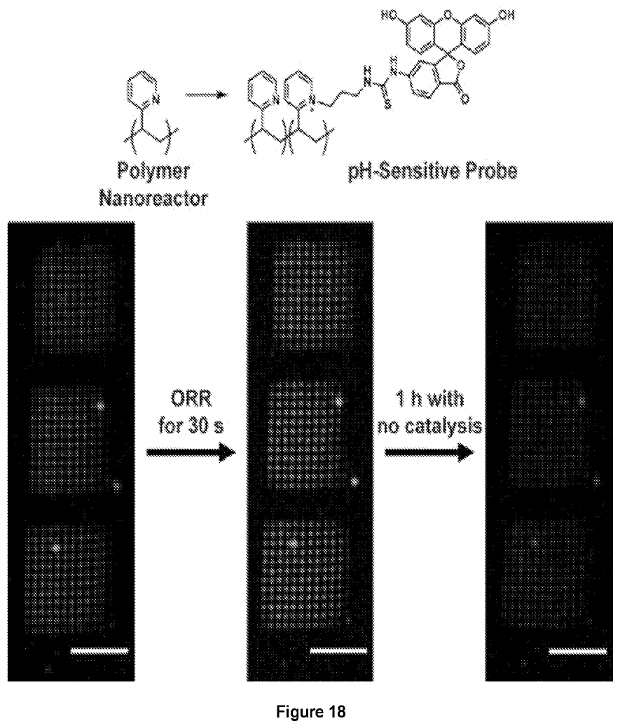

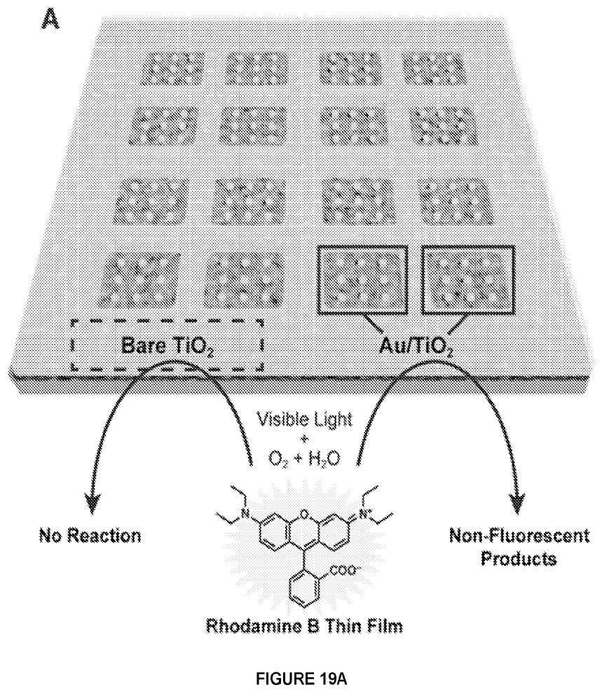

Nanoreactors with Au precursors were annealed at 180° C. for 18 h under H₂ to form single Au NPs in each nanoreactor but without degrading the polymer nanoreactors. The nanoreactors composed of poly(2-vinylpyridine) were then submerged in sodium phosphate buffer containing 1 mg/ml of an alky bromide modified fluorescein derivative (synthesized by reaction of bromopropylamine with fluorescein isothiocyanate). This led to covalent modification as depicted in FIG. 18, and after overnight reaction, the substrate was removed and rinsed of excess reactant. This electrode was then submerged in pH 6 electrolyte saturated with air, and a weak fluorescence was observed. A negative potential was then applied for 30 s to drive ORR, which consumes protons and increases the local pH at the catalyst surface. The fluorescein reactive probe becomes more fluorescent at high pH, and this increase was observed after the electrolysis. The modified nanoreactor catalysts were then allowed to rest for 1 h, after which the fluorescence intensity decreased, indicating that the local pH gradients at the catalyst surface disappeared into the bulk electrolyte since no protons were being consumed in the absence of applied potential. Thus, a fluorescence response using reactive probes is possible at the single nanoreactor/nanoparticle opening up possibilities for truly enormous high throughput screening. If a pattern of nanoparticles can be made where each individual particle has a unique composition or size, then this technique could potentially allow relative characterization of 225,000,000 catalysts in a single minutes-long experiment.

The irreversible fluorescent detection confined at the electrode surface achieved by the methods of the disclosure provides a unique approach to electrocatalysis. For example, ORR catalysts selective for H₂O are vital, but probes for H₂O detection will be challenging to implement. Instead, an approach combining a scanning droplet cell to map overall current across a library and fluorescence screening to map H₂O₂ selectivity can be used to identify catalysts selective for H₂O. Additionally, instead of screening catalyst activity, ABS probes that detect a range of metal cations can be used to screen catalyst stability during long-term operation. This may help reveal the mechanism of degradation to improve catalyst design. This method is amenable to non-electrochemical reactions, as it should work wherever the probe is compatible with the reaction conditions, and the SPBCL/PPL method can make other materials like perovskites. Moreover, alternative library synthesis using ink-jet printing or micro-contact printing can make compositional gradients of other material morphologies for screening. And to further optimize discovery, the abundant characterization data can be coupled with machine learning to design future libraries.

### Example 8: Spatially Controlled Photocatalysis

A uniform pattern of Au nanoparticles on a nanocrystalline anatase TiO₂ thin film was employed in photocatalysis experiments that also confirmed that the lithographic nanoparticle synthesis on polystyrene coated TiO₂ leads to the formation of junctions between the Au and the TiO₂ semiconductor substrate, which is required for electron transport and photocatalysis.

Specifically, patterns of 13.4±1.2 nm Au nanoparticles on TiO₂ were used as catalysts for the photocatalytic degradation of rhodamine B as a model organic pollutant. Such pollutants must be converted into benign substances for remediation, and much effort has identified photocatalytic pathways that use water and oxygen to drive dye degradation through the generation of reactive oxygen species or direct reduction and oxidation mechanisms. TiO₂ itself is known to catalyze the photo-degradation of rhodamine B using UV light, but the addition of Au nanoparticles as a cocatalyst is a viable strategy to boost performance by enhancing visible light absorption, charge separation, or both by taking advantage of the localized surface plasmon resonance (LSPR) of Au. Typically, photocatalytic dye degradation studies are performed with dissolved dye solutions; however, the unique ability of site-specific patterning of the methods of the disclosure offered an approach for site-specific photocatalysis.

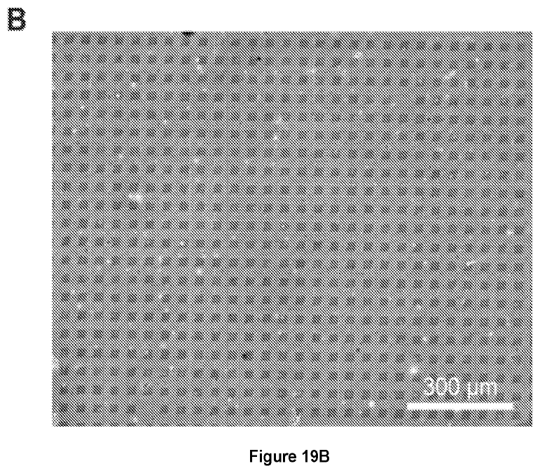

FIG. 19 illustrates the experimental setup used. A repeating pattern of 625 Au nanoparticles with 1 μm spacing in 25×25 μm² squares was formed. Each square array of Au/TiO₂ pattern was separated from neighboring arrays by 25 μm of bare TiO₂ substrate to make clearly defined regions where cocatalyst is patterned. This pattern was subjected to a short 5 s treatment of 30 W air plasma to remove any carbon residue on the particles from incomplete nanoreactor removal that may hinder light absorption or catalysis. Then, a thin film of rhodamine B and poly(2-vinylpyridine) (P2VP) was applied on top of the Au/TiO₂ patterned catalyst by spin coating. P2VP was added to facilitate hydration and oxygen diffusion by increasing the film thickness without adding excessive dye that can directly absorb light and hinder absorption by the underlying catalyst. Next, this coated catalyst platform was placed in a chamber filled with humidified oxygen and irradiated using a 400 W Xe arc lamp for 2 h. Under UV light irradiation where TiO₂ is an effective catalyst for rhodamine B degradation, a uniform loss in fluorescence was observed over the patterned substrate, indicating that the Au cocatalysts do not yield an observable enhancement in degradation over bare TiO₂. In contrast, visible light irradiation using a 435 nm long-pass filter cannot excite electrons over the TiO₂ bandgap for photocatalysis, but it can excite the Au LSPR to generate hot electrons and promote photocatalysis. Fluorescence microscopy post-irradiation with visible light revealed a loss in rhodamine B fluorescence in a square pattern corresponding to the square pattern of Au nanoparticles (FIG. 19B).

This confirmed that the patterned Au nanoparticles were in contact with the underlying anatase TiO₂ substrate, and this combined platform was more effective for the visible light photocatalytic degradation of rhodamine B in the solid state than bare TiO₂. Additionally, catalysis was confined to regions where the Au cocatalysts are deposited. Aggregation of rhodamine B within the thin film during catalysis conditions was observed in regions of intense fluorescence, but it did not significantly interfere. Control experiments using Au nanoparticle patterns on silicon or non-patterned TiO₂ did not show any change in fluorescence under visible light. This demonstration of visible light photocatalysis confirmed the synergy of Au and TiO₂ to overcome the limitations of the wide band gap of TiO₂. Furthermore, the spatial positioning of Au nanoparticles by PPL added a unique level of spatial catalysis control, and the use of a fluorophore interfaced with the patterned substrate proved to be a sufficient proxy to rapidly gauge catalyst activity with high sensitivity.

### Example 9: Megalibraries of Multicomponent Nanoparticles for New Catalyst Discovery

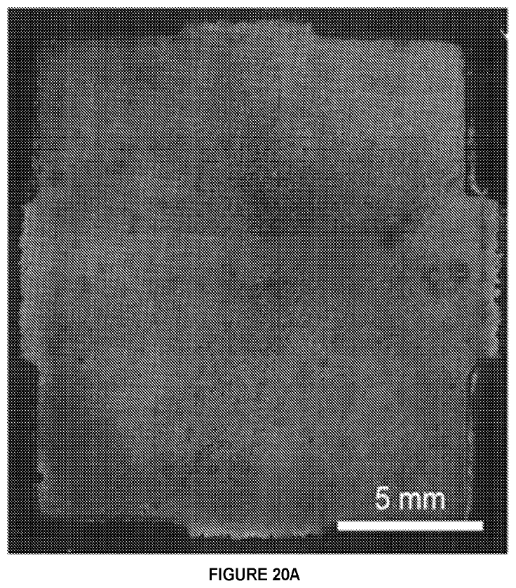

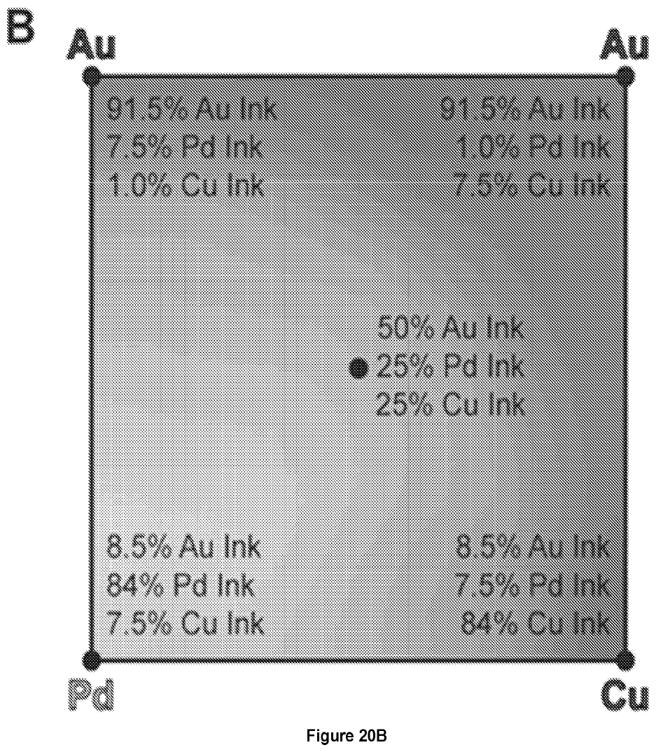

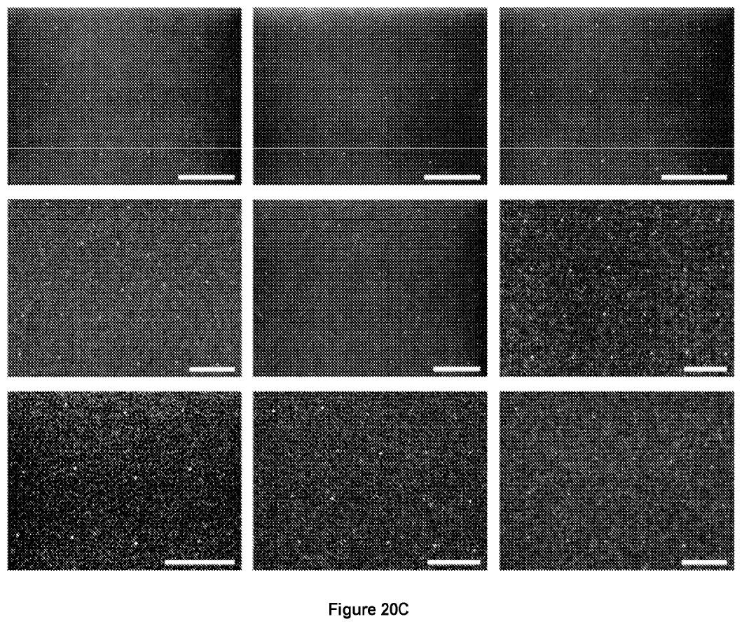

The power of megalibraries for ultrafast materials discovery was demonstrated using photocatalytic degradation of organic pollutants as a facile indicator of catalytic activity. The strategy for using turn-off in fluorescence of rhodamine B thin films during degradation as a proxy for catalyst turnover was applied to a Au—Pd—Cu megalibrary synthesized on TiO₂. Through this method, the relative photocatalytic performance of a total of 90,000 unique nanoparticle compositions with 625 replicates of each were characterized simultaneously since the fluorescence response from nanoparticles patterned by each pen tip can be spatially resolved. Synthetic characterization of the Au—Pd—Cu megalibrary is shown in FIG. 20 with large area nanoreactor formation over 2.25 cm² and uniform single nanoparticle formation after annealing. The predicted composition gradients across the 1.5 cm×1.5 cm substrate are also depicted.

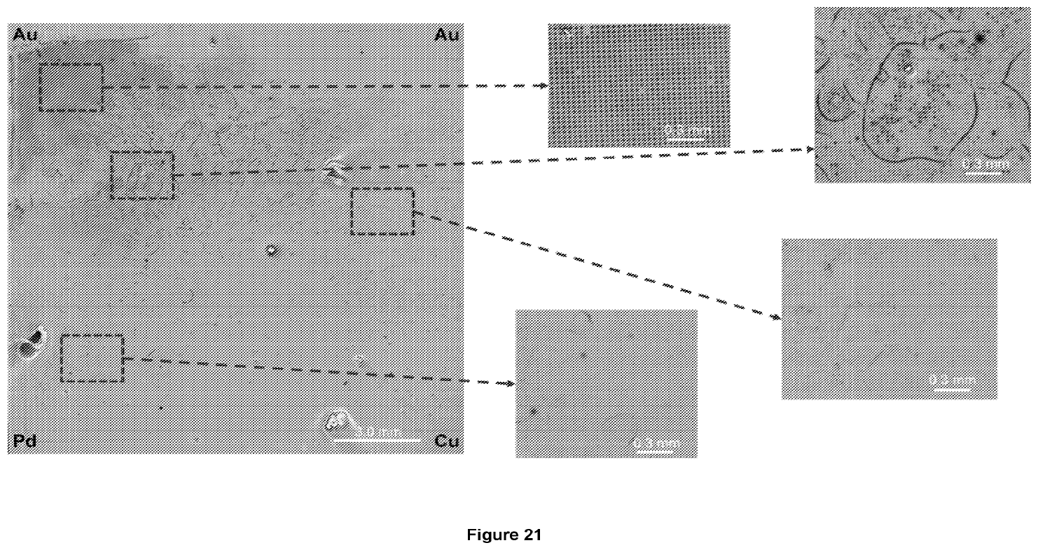

After irradiating the rhodamine B coated Au—Pd—Cu megalibrary with visible light for 30 min, the entire sample was imaged using fluorescence confocal microscopy. FIG. 21 shows square patterns of reduced fluorescence intensity across the entire megalibrary that correspond with the positioning of nanoparticle patterns. Each square of fluorescence represents an individual catalyst performance experiment since each pen tip pattern constitutes a distinct elemental composition. Thus, 90,000 experiments were performed in parallel in only 30 min. FIG. 21 also shows magnified images of selected regions of the megalibrary photocatalysis demonstrating that the extent of fluorescence turn-off depended on the nanoparticle composition and location. The coordinates of the position of the megalibrary with the greatest loss in fluorescence was identified, and using the spray profile analysis from FIG. 20, it was identified that that nanoparticle compositions with Au>Pd>Cu were the best performing photocatalysts within this megalibrary composition space.

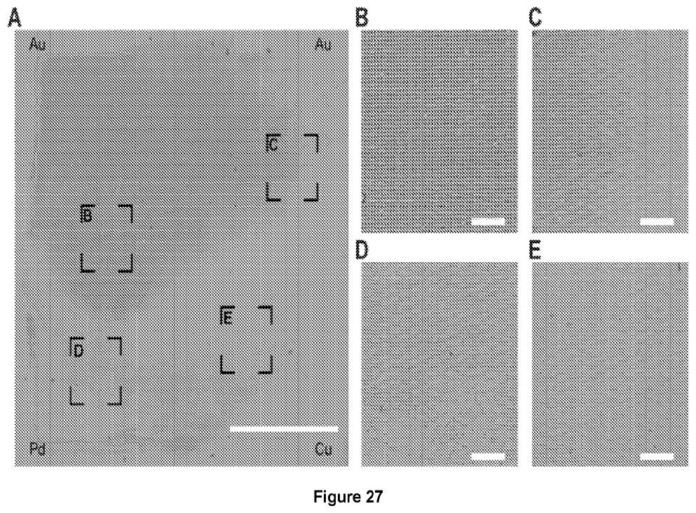

FIG. 27 shows entire megalibrary post-photocatalysis with square patterns of reduced fluorescence intensity that correspond with the positioning of nanoparticle patterns with intensities that vary with the compositional gradients. The differing extents of fluorescence loss indicate variation in catalytic activity. Importantly, each 25 μm×25 μm square of reduced fluorescence represents an individual catalyst performance experiment since each pen tip pattern constitutes a distinct elemental composition. Thus, 90,000 experiments are performed in parallel in only 30 min. FIGS. 1B-E show magnified images of selected regions of the megalibrary photocatalysis demonstrating that the extent of fluorescence turn-off depends on the nanoparticle composition. Multiple replicates were performed to account for any errors due to incomplete patterning or defects due to dust or pinholes during spin coating. To identify the highest performing catalysts, each megalibrary replicate was analyzed to identify the region(s) of lowest fluorescence intensity, which were plotted to reveal two clusters of high catalytic activity. The centroids of the clusters were identified, and using the spray profile analysis, it was discovered Au_{0.53}Pd_{0.38}Cu_{0.09} as the best performing photocatalyst within this megalibrary composition space and under these applied photocatalysis conditions. The second highest performer was identified as Au_{0.85}Pd_{0.12}Cu_{0.03}. Notably, the relative decrease in fluorescence intensity for these catalysts was larger than that observed when using Au nanoparticles, suggesting a higher catalyst performance for the trimetallic species. Beyond materials discovery, megalibrary screening generates a large volume of structure-function relationship data. For example, it was observed that high Au content generally led to good catalyst performance, and incorporation of greater than ˜20% Cu or ˜60% Pd content had detrimental effects on catalysis. Regions of the megalibrary with lowest Au content were consistently the worst performers

### Example 10: Fluorescence Film Probes

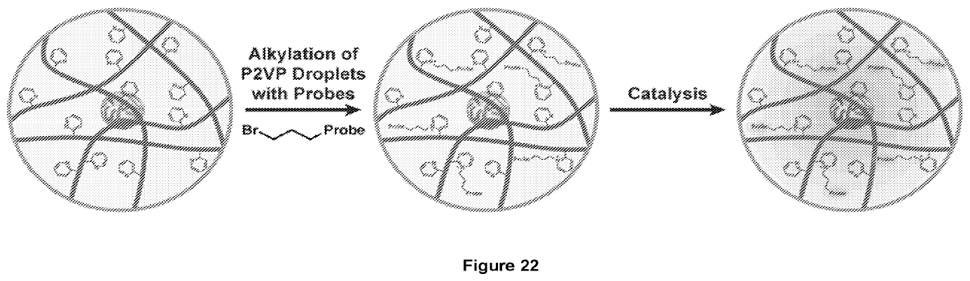

Reactive fluorescent probes can also be readily incorporated into the environment directly surrounding individual nanoparticles, by taking advantage of the spatial confinement of nanoreactors wherein each nanoreactor contains a single nanoparticle or a controlled number of nanoparticles between approximately 1 and 10. The nanoreactor composition containing poly(2-vinylpyridine) (P2VP) has nucleophilic pyridine groups that can act as sites for probe attachment. Inclusion of alkyl bromide moieties into the probe molecular structure enabled facile nanoreactor labeling. Nanoreactor labeling was performed by submerging a substrate patterned with P2VP nanoreactors in a pH 7.4 phosphate buffered saline solution containing 1 mg/mL of probe and letting sit overnight followed by extensive washing with water. This fluorescent sensing within discrete nanoreactors provides an easily observable signal for single nanoparticle catalytic activity, which typically requires more complicated experimentation (FIG. 22).

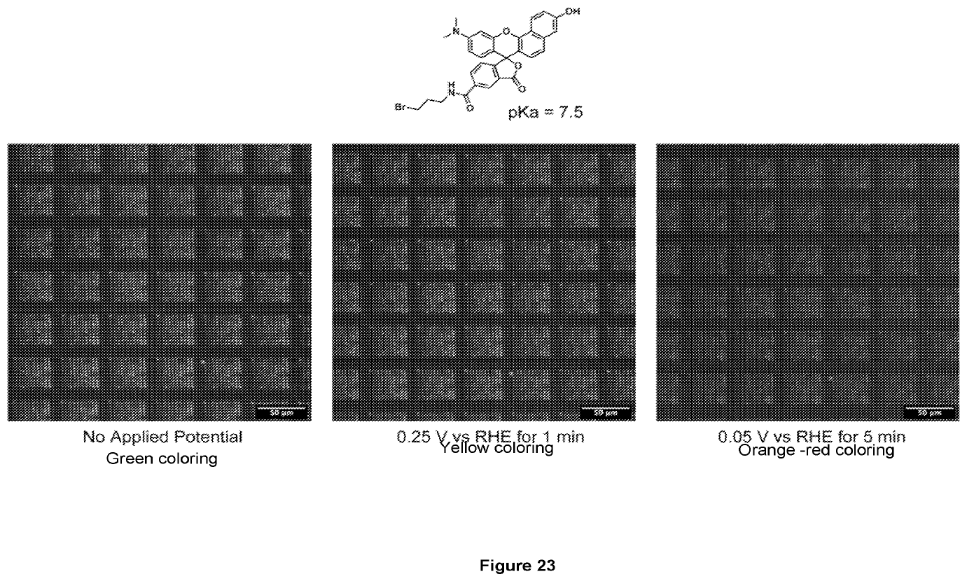

A pH-sensitive seminaptharhodafluor (SNARF) fluorescent dye modified with an alkyl bromide functional group that enabled covalent attachment to the patterned nanoreactors was prepared (FIG. 23). Changes in pH occur in many electrocatalytic reactions due to the consumption or formation of protons; thus, the SNARF probe can behave as a sensor for overall catalyst performance for reactions that induce pH changes. For example, the oxygen reduction reaction (ORR) converts oxygen into either water or hydrogen peroxide with the consumption of either 4 or 2 protons, respectively. Catalysts capable of promoting the ORR will induce local increases in pH, where a greater pH increase indicated higher catalyst activity. The SNARF dye allows pH visualization, where below the pKa of 7.5 the dye is predominantly in the closed form and fluoresces at 580 nm, whereas in pH above 7.5 the open form will fluoresce at 640 nm. The ratio of these two emission intensities can be used to gauge the local pH.

A pattern of P2VP nanoreactors containing 1-10 Au nanoparticles each and functionalized them with the SNARF-Br probe. This sample was submerged in 0.1 M NaClO₄ pH 6 electrolyte saturated with air and imaged by confocal fluorescence microscopy. FIG. 23 first shows the overlaid fluorescence at 580 and 640 nm with no applied potential, false colored as green and red, respectively, and the green color was most intense (color not shown in the image). Upon applying a potential of 0.25 V vs RHE for 1 min to drive the ORR, a color change to yellow was observed. Then applying a potential of 0.05 V vs RHE for 5 min to more strongly drive ORR, a change to orange-red was seen. These results showed an increase in pH upon applied potential that was more intense at less positive potentials, which is as expected due to the greater extent of ORR at these potentials.

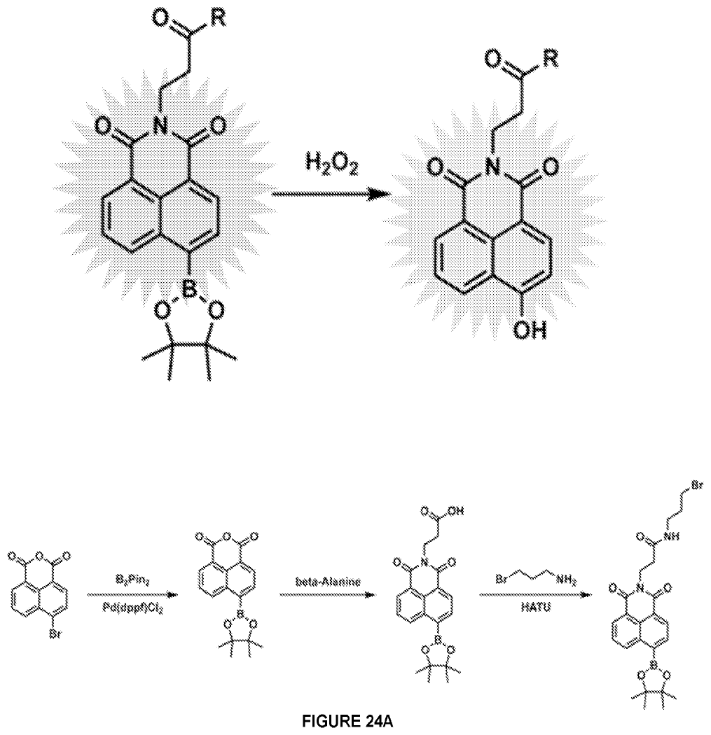

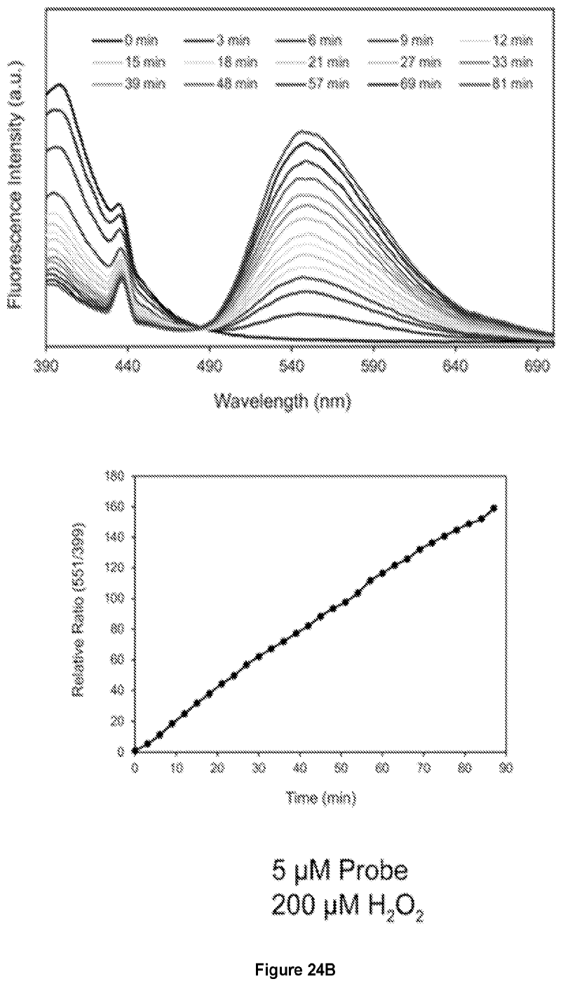

While the SNARF probe allowed visualization of pH changes during catalysis, which acted as a proxy for overall catalyst turnover, there was no insight into the product distribution. To determine the selectivity during ORR towards water or hydrogen peroxide, reactive probes were synthesized that chemoselectively react with hydrogen peroxide. FIG. 24 depicts the synthesis and characterization of a naphthalimide fluorophore possessing a boronate group known to react selectively with hydrogen peroxide to induce fluorescence changes. An alkyl bromide functional group was also included for nanoreactor attachment. Fluorescence spectroscopy was performed with a 5 μM solution of probe with added 200 μM hydrogen peroxide, which showed a decrease in fluorescence at 400 nm with a concomitant increase in fluorescence at 545 nm. Thus, the ratio of these two emission intensities can be used to gauge the hydrogen peroxide concentration.

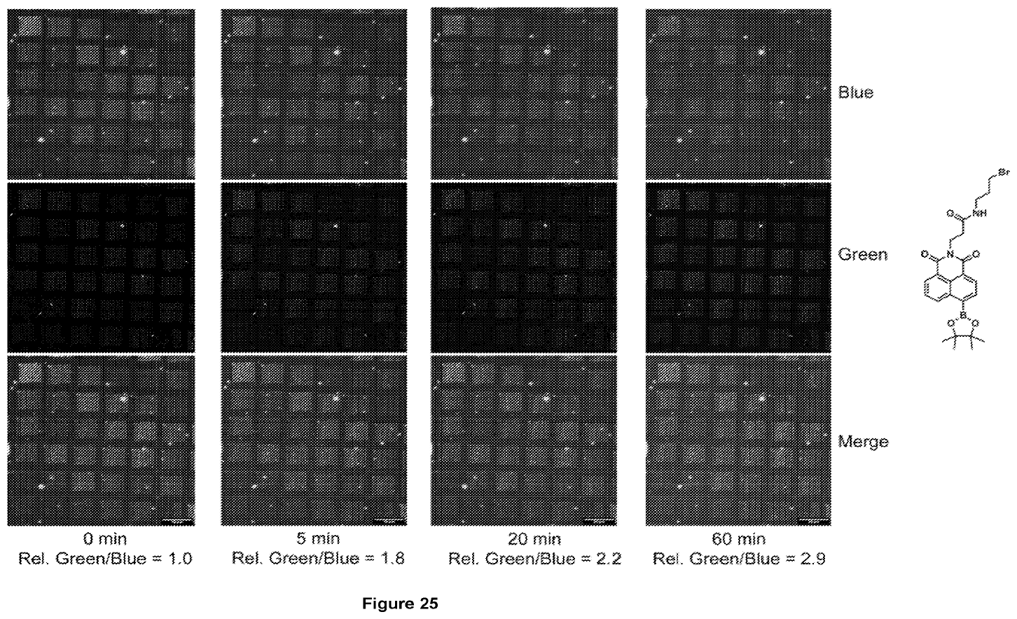

The naphthalimide boronate probe was covalently attached to a pattern of P2VP nanoreactors and submerged in a solution of 100 UM hydrogen peroxide at pH 7. Referring to FIG. 25, fluorescence microscopy was used to monitor the blue and green fluorescence intensities, which showed over time a decrease and increase, respectively. These changes mimic those from the fluorescence spectroscopy and indicated that the probe-labeled nanoreactors can be used to visualize hydrogen peroxide. A relative green/blue ratio increased from 1.0 to 2.9 over 60 min.

### Example 11: Visualizing Electrocatalysis Products at Nanoparticle Patterns

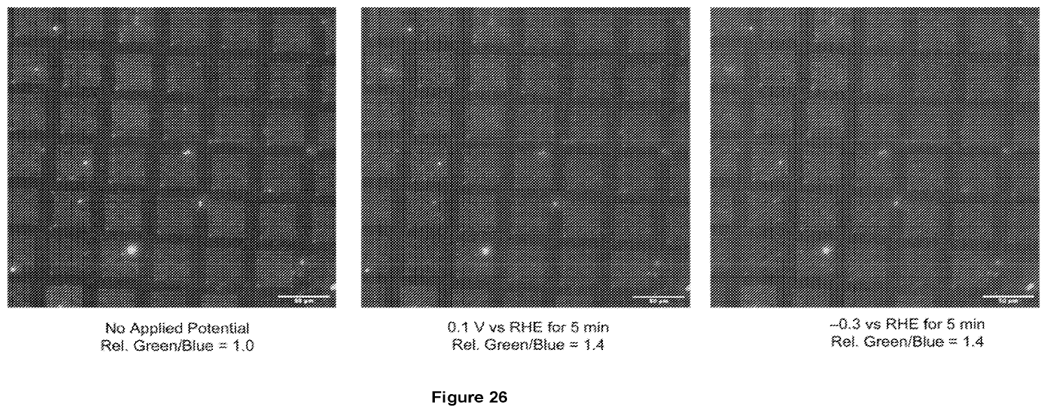

To visualize hydrogen peroxide formed in situ during ORR, P2VP nanoreactors were patterned with Au precursors, and thermally annealed to form 1-10 Au nanoparticles per nanoreactor. The nanoreactors were subsequently labeled with the naphthalimide boronate probe. This was submerged in 0.1 M NaClO₄ pH 6 electrolyte saturated with air, and the patterns initially showed strong blue fluorescence with minimal green fluorescence. Upon applying a potential of 0.1 V vs RHE for 5 min and then-0.3 V vs RHE for 5 min, the green fluorescence was observed to increase slightly (FIG. 26). The ratio of green to blue fluorescence can be quantified and showed an increase from 1.0 to 1.4, demonstrating a modest change in color from blue to green fluorescence. This showed that electrochemically generated hydrogen peroxide can be detected in situ by probe-labeled nanoreactors. This spatiotemporal visualization of catalyst activity and selectivity during electrocatalysis is unprecedented and offers a unique method for characterizing and screening electrocatalyst platforms.

This merging of two enormous fields-materials synthesis and chemical/biology sensing-will achieve the ultimate goal of a truly generalizable screening method: if a materials library can be synthesized and a probe can be developed to sense a desired species, then this strategy enables rapid and extensive characterization. Greatly accelerating high throughput experimentation will address many academic and commercial challenges of discovering materials and bringing them to market, shortening the time to impart improvements on the global energy economy.

The foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

### REFERENCES

U.S. Pat. No. 10,474,029B2
U.S. Patent Application Publication No. 2015/0210868A1
U.S. Pat. No. 10,203,598B2
Huo, F.; Zheng, Z.; Zheng, G.; Giam, L. R.; Zhang, H.; Mirkin, C. A., Polymer pen lithography. Science 2008, 321 (5896), 1658-60.
Chai, J.; Huo, F.; Zheng, Z.; Giam, L. R.; Shim, W.; Mirkin, C. A., Scanning probe block copolymer lithography. Proc. Natl. Acad. Sci. U.S.A. 2010, 107 (47), 20202-6. Kluender, E. J.; Hedrick, J. L.; Brown, K. A.; Rao, R.; Meckes, B.; Du, J. S.; Moreau, L. M.; Maruyama, B.; Mirkin, C. A., Catalyst discovery through megalibraries of nanomaterials. Proc. Natl. Acad. Sci. U.S.A. 2019, 116 (1), 40-45.
Chang, M. C.; Pralle, A.; Isacoff, E. Y.; Chang, C. J., A selective, cell-permeable optical probe for hydrogen peroxide in living cells. J. Am. Chem. Soc. 2004, 126 (47), 15392-3. Hitt, J. L.; Li, Y. C.; Tao, S.; Yan, Z.; Gao, Y.; Billinge, S. J. L.; Mallouk, T. E., A high throughput optical method for studying compositional effects in electrocatalysts for CO2 reduction. Nat. Commun. 2021, 12 (1), 1114.
Xiang, X. D.; Sun, X.; Briceno, G.; Lou, Y.; Wang, K. A.; Chang, H.; Wallace-Freedman, W. G.; Chen, S. W.; Schultz, P. G. A combinatorial approach to materials discovery. Science 1995, 268, 1738-1740.
Correa-Baena, J.-P.; Hippalgaonkar, K.; van Duren, J.; Jaffer, S.; Chandrasekhar, V. R.; Stevanovic, V.; Wadia, C.; Guha, S.; Buonassisi, T. Accelerating Materials Development via Automation, Machine Learning, and High-Performance Computing. Joule 2018, 2, 1410-1420.
Macleod, B. P.; Parlane, F. G. L.; Morrissey, T. D.; Hase, F.; Roch, L. M.; Dettelbach, K. E.; Moreira, R.; Yunker, L. P. E.; Rooney, M. B.; Deeth, J. R.; Lai, V.; Ng, G. J.; Situ, H.; Zhang, R. H.; Elliott, M. S.; Haley, T. H.; Dvorak, D. J.; Aspuru-Guzik, A.; Hein, J. E.; Berlinguette, C. P. Self-driving laboratory for accelerated discovery of thin-film materials. Sci. Adv. 2020, 6, eaaz8867.
Linnemann, J.; Kanokkanchana, K.; Tschulik, K. Design Strategies for Electrocatalysts from an Electrochemist's Perspective. ACS Catal. 2021, 11, 5318-5346.
Lewis, N. S.; Nocera, D. G. Powering the planet: chemical challenges in solar energy utilization. Proc. Natl. Acad. Sci. U.S.A. 2006, 103, 15729-15735.
De Luna, P.; Hahn, C.; Higgins, D.; Jaffer, S. A.; Jaramillo, T. F.; Sargent, E. H. What would it take for renewably powered electrosynthesis to displace petrochemical processes? Science 2019, 364, eaav3506.
Yan, Z.; Hitt, J. L.; Turner, J. A.; Mallouk, T. E. Renewable electricity storage using electrolysis. Proc. Natl. Acad. Sci. U.S.A. 2020, 117, 12558-12563.
Masel, R. I.; Liu, Z.; Yang, H.; Kaczur, J. J.; Carrillo, D.; Ren, S.; Salvatore, D.; Berlinguette, C. P. An industrial perspective on catalysts for low-temperature CO₂ electrolysis. Nat. Nanotechnol. 2021, 16, 118-128.
Dey, S.; Mondal, B.; Chatterjee, S.; Rana, A.; Amanullah, S.; Dey, A. Molecular electrocatalysts for the oxygen reduction reaction. Nat. Rev. Chem. 2017, 1, 0098.
Pegis, M. L.; Wise, C. F.; Martin, D. J.; Mayer, J. M. Oxygen Reduction by Homogeneous Molecular Catalysts and Electrocatalysts. Chem. Rev. 2018, 118, 2340-2391.
Rosenthal, J.; Nocera, D. G. Role of proton-coupled electron transfer in O—O bond activation. Acc. Chem. Res. 2007, 40, 543-553.
Kim, H. W.; Ross, M. B.; Kornienko, N.; Zhang, L.; Guo, J.; Yang, P.; McCloskey, B. D. Efficient hydrogen peroxide generation using reduced graphene oxide-based oxygen reduction electrocatalysts. Nat. Catal. 2018, 1, 282-290.
Jiang, K.; Back, S.; Akey, A. J.; Xia, C.; Hu, Y.; Liang, W.; Schaak, D.; Stavitski, E.; Norskov, J. K.; Siahrostami, S.; Wang, H. Highly selective oxygen reduction to hydrogen peroxide on transition metal single atom coordination. Nat. Commun. 2019, 10, 3997.
Jiang, K.; Zhao, J.; Wang, H. Catalyst Design for Electrochemical Oxygen Reduction toward Hydrogen Peroxide. Adv. Funct. Mater. 2020, 30, 2003321.
Marshall-Roth, T.; Libretto, N. J.; Wrobel, A. T.; Anderton, K. J.; Pegis, M. L.; Ricke, N. D.; Voorhis, T. V.; Miller, J. T.; Surendranath, Y. A pyridinic Fe—N₄ macrocycle models the active sites in Fe/N-doped carbon electrocatalysts. Nat. Commun. 2020, 11, 5283.
Appel, A. M.; Bercaw, J. E.; Bocarsly, A. B.; Dobbek, H.; DuBois, D. L.; Dupuis, M.; Ferry, J. G.; Fujita, E.; Hille, R.; Kenis, P. J.; Kerfeld, C. A.; Morris, R. H.; Peden, C. H.; Portis, A. R.; Ragsdale, S. W.; Rauchfuss, T. B.; Reek, J. N.; Seefeldt, L. C.; Thauer, R. K.; Waldrop, G. L. Frontiers, opportunities, and challenges in biochemical and chemical catalysis of CO₂ fixation. Chem. Rev. 2013, 113, 6621-6658.
Francke, R.; Schille, B.; Roemelt, M. Homogeneously Catalyzed Electroreduction of Carbon Dioxide-Methods, Mechanisms, and Catalysts. Chem. Rev. 2018, 118, 4631-4701.
Costentin, C.; Drouet, S.; Robert, M.; Saveant, J. M. A local proton source enhances CO₂ electroreduction to CO by a molecular Fe catalyst. Science 2012, 338, 90-94.
Kim, D.; Resasco, J.; Yu, Y.; Asiri, A. M.; Yang, P. Synergistic geometric and electronic effects for electrochemical reduction of carbon dioxide using gold-copper bimetallic nanoparticles. Nat. Commun. 2014, 5, 4948.
Lin, S.; Diercks, C. S.; Zhang, Y. B.; Kornienko, N.; Nichols, E. M.; Zhao, Y.; Paris, A. R.; Kim, D.; Yang, P.; Yaghi, O. M.; Chang, C. J. Covalent organic frameworks comprising cobalt porphyrins for catalytic CO₂ reduction in water. Science 2015, 349, 1208-1213.
Ren, S.; Joulie, D.; Salvatore, D.; Torbensen, K.; Wang, M.; Robert, M.; Berlinguette, C. P. Molecular electrocatalysts can mediate fast, selective CO₂ reduction in a flow cell. Science 2019, 365, 367-369.
Li, F.; Thevenon, A.; Rosas-Hernandez, A.; Wang, Z.; Li, Y.; Gabardo, C. M.; Ozden, A.; Dinh, C. T.; Li, J.; Wang, Y.; Edwards, J. P.; Xu, Y.; McCallum, C.; Tao, L.; Liang, Z. Q.; Luo, M.; Wang, X.; Li, H.; O'Brien, C. P.; Tan, C. S.; Nam, D. H.; Quintero-Bermudez, R.; Zhuang, T. T.; Li, Y. C.; Han, Z.; Britt, R. D.; Sinton, D.; Agapie, T.; Peters, J. C.; Sargent, E. H. Molecular tuning of CO₂-to-ethylene conversion. Nature 2020, 577, 509-513.
Ceballos, B. M.; Yang, J. Y. Directing the reactivity of metal hydrides for selective CO₂ reduction. Proc. Natl. Acad. Sci. U.S.A. 2018, 115, 12686-12691.
Kluender, E. J.; Hedrick, J. L.; Brown, K. A.; Rao, R.; Meckes, B.; Du, J. S.; Moreau, L. M.; Maruyama, B.; Mirkin, C. A. Catalyst discovery through megalibraries of nanomaterials. Proc. Natl. Acad. Sci. U.S.A. 2019, 116, 40-45.
Chai, J.; Huo, F.; Zheng, Z.; Giam, L. R.; Shim, W.; Mirkin, C. A. Scanning probe block copolymer lithography. Proc. Natl. Acad. Sci. U.S.A. 2010, 107, 20202-20206.
Chen, P. C.; Liu, X.; Hedrick, J. L.; Xie, Z.; Wang, S.; Lin, Q. Y.; Hersam, M. C.; Dravid, V. P.; Mirkin, C. A. Polyelemental nanoparticle libraries. Science 2016, 352, 1565-1569.
Huo, F.; Zheng, Z.; Zheng, G.; Giam, L. R.; Zhang, H.; Mirkin, C. A. Polymer pen lithography. Science 2008, 321, 1658-1660.
Yang, Y.; Zhao, Q.; Feng, W.; Li, F. Luminescent chemodosimeters for bioimaging. Chem. Rev. 2013, 113, 192-270.
Bruemmer, K. J.; Crossley, S. W. M.; Chang, C. J. Activity-Based Sensing: A Synthetic Methods Approach for Selective Molecular Imaging and Beyond. Angew. Chem. Int. Ed. 2020, 59, 13734-13762.
Seh, Z. W.; Kibsgaard, J.; Dickens, C. F.; Chorkendorff, I.; Norskov, J. K.; Jaramillo, T. F. Combining theory and experiment in electrocatalysis: Insights into materials design. Science 2017, 355, eaad4998.
He, J.; Dettelbach, K. E.; Salvatore, D. A.; Li, T.; Berlinguette, C. P. High-Throughput Synthesis of Mixed-Metal Electrocatalysts for CO₂ Reduction. Angew. Chem. Int. Ed. 2017, 56, 6068-6072.
Liu, X.; Shen, Y.; Yang, R.; Zou, S.; Ji, X.; Shi, L.; Zhang, Y.; Liu, D.; Xiao, L.; Zheng, X.; Li, S.; Fan, J.; Stucky, G. D. Inkjet printing assisted synthesis of multicomponent mesoporous metal oxides for ultrafast catalyst exploration. Nano Lett. 2012, 12, 5733-5739.
Yang, Y.; Chen, G.; Zeng, R.; Villarino, A. M.; DiSalvo, F. J.; van Dover, R. B.; Abruna, H. D. Combinatorial Studies of Palladium-Based Oxygen Reduction Electrocatalysts for Alkaline Fuel Cells. J. Am. Chem. Soc. 2020, 142, 3980-3988.
Guerin, S.; Hayden, B. E.; Lee, C. E.; Mormiche, C.; Owen, J. R.; Russell, A. E.; Theobald, B.; Thompsett, D. Combinatorial electrochemical screening of fuel cell electrocatalysts. J. Comb. Chem. 2004, 6, 149-158.
Greeley, J.; Jaramillo, T. F.; Bonde, J.; Chorkendorff, I. B.; Norskov, J. K. Computational high-throughput screening of electrocatalytic materials for hydrogen evolution. Nat. Mater. 2006, 5, 909-913.
Singh, A. K.; Montoya, J. H.; Gregoire, J. M.; Persson, K. A. Robust and synthesizable photocatalysts for CO₂ reduction: a data-driven materials discovery. Nat. Commun. 2019, 10, 443.
Gregoire, J. M.; Xiang, C.; Liu, X.; Marcin, M.; Jin, J. Scanning droplet cell for high throughput electrochemical and photoelectrochemical measurements. Rev. Sci. Instrum. 2013, 84, 024102.
Shinde, A.; Jones, R. J. R.; Guevarra, D.; Mitrovic, S.; Becerra-Stasiewicz, N.; Haber, J. A.; Jin, J.; Gregoire, J. M. High-Throughput Screening for Acid-Stable Oxygen Evolution Electrocatalysts in the (Mn—Co—Ta—Sb) Ox Composition Space. Electrocatalysis 2014, 6, 229-236.
Bentley, C. L.; Kang, M.; Unwin, P. R. Nanoscale Structure Dynamics within Electrocatalytic Materials. J. Am. Chem. Soc. 2017, 139, 16813-16821.
Lai, Y.; Jones, R. J. R.; Wang, Y.; Zhou, L.; Gregoire, J. M. Scanning Electrochemical Flow Cell with Online Mass Spectroscopy for Accelerated Screening of Carbon Dioxide Reduction Electrocatalysts. ACS Comb. Sci. 2019, 21, 692-704.
Yao, Y.; Huang, Z.; Li, T.; Wang, H.; Liu, Y.; Stein, H. S.; Mao, Y.; Gao, J.; Jiao, M.; Dong, Q.; Dai, J.; Xie, P.; Xie, H.; Lacey, S. D.; Takeuchi, I.; Gregoire, J. M.; Jiang, R.; Wang, C.; Taylor, A. D.; Shahbazian-Yassar, R.; Hu, L. High-throughput, combinatorial synthesis of multimetallic nanoclusters. Proc. Natl. Acad. Sci. U.S.A. 2020, 117, 6316-6322.
Batchelor, T. A. A.; Loffler, T.; Xiao, B.; Krysiak, O. A.; Strotkotter, V.; Pedersen, J. K.; Clausen, C. M.; Savan, A.; Li, Y.; Schuhmann, W.; Rossmeisl, J.; Ludwig, A. Complex-Solid-Solution Electrocatalyst Discovery by Computational Prediction and High-Throughput Experimentation. Angew. Chem. Int. Ed. 2021, 60, 6932-6937.
Reddington, E.; Sapienza, A.; Gurau, B.; Viswanathan, R.; Sarangapani, S.; Smotkin, E. S.; Mallouk, T. E. Combinatorial electrochemistry: A highly parallel, optical screening method for discovery of better electrocatalysts. Science 1998, 280, 1735-1737.
Tague, M. E.; Gregoire, J. M.; Legard, A.; Smith, E.; Dale, D.; Hennig, R.; DiSalvo, F. J.; Bruce van Dover, R.; Abruna, H. D. High Throughput Thin Film Pt-M Alloys for Fuel Electrooxidation: Low Concentrations of M (M=Sn, Ta, W, Mo, Ru, Fe, In, Pd, Hf, Zn, Zr, Nb, Sc, Ni, Ti, V, Cr, Rh). J. Electrochem. Soc. 2012, 159, F880-F887.
Hitt, J. L.; Li, Y. C.; Tao, S.; Yan, Z.; Gao, Y.; Billinge, S. J. L.; Mallouk, T. E. A high throughput optical method for studying compositional effects in electrocatalysts for CO₂ reduction. Nat. Commun. 2021, 12, 1114.
11
Primo, A.; Corma, A.; Garcia, H. Titania supported gold nanoparticles as photocatalyst. Phys. Chem. Chem. Phys. 2011, 13, 886-910.
Li, Z.; Meng, X. Recent development on palladium enhanced photocatalytic activity: A review. J. Alloys Compd. 2020, 830, 154669.
Xin, Y.; Yu, K.; Zhang, L.; Yang, Y.; Yuan, H.; Li, H.; Wang, L.; Zeng, J. Copper-Based Plasmonic Catalysis: Recent Advances and Future Perspectives. Adv. Mater. 2021, 33, e2008145.
Meng, A.; Zhang, L.; Cheng, B.; Yu, J. Dual Cocatalysts in TiO₂ Photocatalysis. Adv. Mater. 2019, 31, e1807660.
Padre, S. M.; Kiruthika, S.; Mundinamani, S.; Ravikirana; Surabhi, S.; Jeong, J. R.; Eshwarappa, K. M.; Murari, M. S.; Shetty, V.; Ballal, M.; S, C. G. Mono- and Bimetallic Nanoparticles for Catalytic Degradation of Hazardous Organic Dyes and Antibacterial Applications. ACS Omega 2022, 7, 35023-35034.
Misra, M.; Singh, N.; Gupta, R. K. Enhanced visible-light-driven photocatalytic activity of Au@Ag core-shell bimetallic nanoparticles immobilized on electrospun TiO₂ nanofibers for degradation of organic compounds. Catal. Sci. Technol. 2017, 7, 570-580.
Sahoo, A.; Tripathy, S. K.; Dehury, N.; Patra, S. A porous trimetallic Au@Pd@Ru nanoparticle system: synthesis, characterisation and efficient dye degradation and removal. J. Mater. Chem. A 2015, 3, 19376-19383.
Lippert, A. R.; Van de Bittner, G. C.; Chang, C. J. Boronate oxidation as a bioorthogonal reaction approach for studying the chemistry of hydrogen peroxide in living systems. Acc. Chem. Res. 2011, 44, 793-804.
Zhang, Y.; Fu, Y.-Y.; Zhu, D.-F.; Xu, J.-Q.; He, Q.-G.; Cheng, J.-G. Recent advances in fluorescence sensor for the detection of peroxide explosives. Chin. Chem. Lett. 2016, 27, 1429-1436.
Kutz, R. B.; Chen, Q.; Yang, H.; Sajjad, S. D.; Liu, Z.; Masel, I. R. Sustainion Imidazolium-Functionalized Polymers for Carbon Dioxide Electrolysis. Energy Technol. 2017, 5, 929-936.
Andina, D.; Leroux, J. C.; Luciani, P. Ratiometric Fluorescent Probes for the Detection of Reactive Oxygen Species. Chem. Eur. J. 2017, 23, 13549-13573.
Nam, D.-H.; De Luna, P.; Rosas-Hernandez, A.; Thevenon, A.; Li, F.; Agapie, T.; Peters, J. C.; Shekhah, O.; Eddaoudi, M.; Sargent, E. H. Molecular enhancement of heterogeneous CO₂ reduction. Nature Materials 2020, 19, 266-276.
Jirkovsky, J. S.; Panas, I.; Ahlberg, E.; Halasa, M.; Romani, S.; Schiffrin, D. J. Single atom hot-spots at Au—Pd nanoalloys for electrocatalytic H₂O₂ production. J. Am. Chem. Soc. 2011, 133, 19432-19441.
Freakley, S. J.; He, Q.; Harrhy, J. H.; Lu, L.; Crole, D. A.; Morgan, D. J.; Ntainjua, E. N.; Edwards, J. K.; Carley, A. F.; Borisevich, A. Y.; Kiely, C. J.; Hutchings, G. J. Palladium-tin catalysts for the direct synthesis of H₂O₂ with high selectivity. Science 2016, 351, 965-968.
Siahrostami, S.; Verdaguer-Casadevall, A.; Karamad, M.; Deiana, D.; Malacrida, P.; Wickman, B.; Escudero-Escribano, M.; Paoli, E. A.; Frydendal, R.; Hansen, T. W.; Chorkendorff, I.; Stephens, I. E.; Rossmeisl, J. Enabling direct H₂O₂ production through rational electrocatalyst design. Nat. Mater. 2013, 12, 1137-1143.
Bruemmer, K. J.; Walvoord, R. R.; Brewer, T. F.; Burgos-Barragan, G.; Wit, N.; Pontel, L. B.; Patel, K. J.; Chang, C. J. Development of a General Aza-Cope Reaction Trigger Applied to Fluorescence Imaging of Formaldehyde in Living Cells. J. Am. Chem. Soc. 2017, 139, 5338-5350.
Toussaint, S. N. W.; Calkins, R. T.; Lee, S.; Michel, B. W. Olefin Metathesis-Based Fluorescent Probes for the Selective Detection of Ethylene in Live Cells. J. Am. Chem. Soc. 2018, 140, 13151-13155.
Sun, M.; Yu, H.; Zhang, K.; Wang, S.; Hayat, T.; Alsaedi, A.; Huang, D. Palladacycle Based Fluorescence Turn-On Probe for Sensitive Detection of Carbon Monoxide. ACS Sens. 2018, 3, 285-289.
Chen, P. C.; Liu, M.; Du, J. S.; Meckes, B.; Wang, S.; Lin, H.; Dravid, V. P.; Wolverton, C.; Mirkin, C. A. Interface and heterostructure design in polyelemental nanoparticles. Science 2019, 363, 959-964.
Yan, M.; Harnish, B. A Simple Method for the Attachment of Polymer Films on Solid Substrates. Adv. Mater. 2003, 15, 244-248.
Singha, S.; Jun, Y. W.; Sarkar, S.; Ahn, K. H. An Endeavor in the Reaction-Based Approach to Fluorescent Probes for Biorelevant Analytes: Challenges and Achievements. Acc. Chem. Res. 2019, 52, 2571-2581.
Iovan, D. A.; Jia, S.; Chang, C. J. Inorganic Chemistry Approaches to Activity-Based Sensing: From Metal Sensors to Bioorthogonal Metal Chemistry. Inorg. Chem. 2019, 58, 13546-13560.
Du, J. S.; Shin, D.; Stanev, T. K.; Musumeci, C.; Xie, Z.; Huang, Z.; Lai, M.; Sun, L.; Zhou, W.; Stern, N. P.; Dravid, V. P.; Mirkin, C. A. Halide perovskite nanocrystal arrays: Multiplexed synthesis and size-dependent emission. Sci. Adv. 2020, 6, eabc4959.
(62) Tabor, D. P.; Roch, L. M.; Saikin, S. K.; Kreisbeck, C.; Sheberla, D.; Montoya, J. H.; Dwaraknath, S.; Aykol, M.; Ortiz, C.; Tribukait, H.; Amador-Bedolla, C.; Brabec, C. J.; Maruyama, B.; Persson, K. A.; Aspuru-Guzik, A. Accelerating the discovery of materials for clean energy in the era of smart automation. Nat. Rev. Mater. 2018, 3, 5-20.
Prieto, G.; Zecevic, J.; Friedrich, H.; de Jong, K. P.; de Jongh, P. E. Towards stable catalysts by controlling collective properties of supported metal nanoparticles. Nat. Mater. 2013, 12, 34-39.
Manthiram, K.; Surendranath, Y.; Alivisatos, A. P. Dendritic assembly of gold nanoparticles during fuel-forming electrocatalysis. J. Am. Chem. Soc. 2014, 136, 7237-7240.
Goodman, E. D.; Johnston-Peck, A. C.; Dietze, E. M.; Wrasman, C. J.; Hoffman, A. S.; Abild-Pedersen, F.; Bare, S. R.; Plessow, P. N.; Cargnello, M. Supported Catalyst Deactivation by Decomposition into Single Atoms Is Suppressed by Increasing Metal Loading. Nat Catal 2019, 2, 748-755.
Primo, A.; Corma, A.; Garcia, H. Titania supported gold nanoparticles as photocatalyst. Phys. Chem. Chem. Phys. 2011, 13, 886-910.
Ajmal, A.; Majeed, I.; Malik, R. N.; Idriss, H.; Nadeem, M. A. Principles and mechanisms of photocatalytic dye degradation on TiO₂ based photocatalysts: a comparative overview. RSC Adv. 2014, 4, 37003-37026.
Aarthi, T.; Madras, G. Photocatalytic Degradation of Rhodamine Dyes with Nano-TiO₂. Ind. Eng. Chem. Res. 2006, 46, 7-14.
Bian, Z.; Tachikawa, T.; Zhang, P.; Fujitsuka, M.; Majima, T. Au/TiO₂ superstructure-based plasmonic photocatalysts exhibiting efficient charge separation and unprecedented activity. J. Am. Chem. Soc. 2014, 136, 458-465.
Lee, S. Y.; Kang, D.; Jeong, S.; Do, H. T.; Kim, J. H. Photocatalytic Degradation of Rhodamine B Dye by TiO₂ and Gold Nanoparticles Supported on a Floating Porous Polydimethylsiloxane Sponge under Ultraviolet and Visible Light Irradiation. ACS Omega 2020, 5, 4233-4241.
Veziroglu, S.; Obermann, A. L.; Ullrich, M.; Hussain, M.; Kamp, M.; Kienle, L.; Leissner, T.; Rubahn, H. G.; Polonskyi, O.; Strunskus, T.; Fiutowski, J.; Es-Souni, M.; Adam, J.; Faupel, F.; Aktas, O. C. Photodeposition of Au Nanoclusters for Enhanced Photocatalytic Dye Degradation over TiO₂ Thin Film. ACS Appl. Mater. Interfaces 2020, 12, 14983-14992.
Rafiq, A.; Ikram, M.; Ali, S.; Niaz, F.; Khan, M.; Khan, Q.; Maqbool, M. Photocatalytic degradation of dyes using semiconductor photocatalysts to clean industrial water pollution. J. Ind. Eng. Chem. 2021, 97, 111-128.
Clavero, C. Plasmon-induced hot-electron generation at nanoparticle/metal-oxide interfaces for photovoltaic and photocatalytic devices. Nat. Photonics 2014, 8, 95-103.

1. A method of simultaneously testing catalytic activity and/or selectivity of a plurality of catalyst, comprising:
coating a substrate having the plurality of catalyst with a polymer thin film comprising one or more reactive probes to form a coated substrate, each reactive probe comprising a signaling component that generates an optical signal upon reaction of the one or more reactive probes with a product of the target catalytic activity and/or selectivity, thereby allowing sensing and signaling of the product of the target catalytic activity and/or selectivity;
subjecting the coated substrate to catalysis conditions corresponding to the target catalytic activity and/or selectivity;
imaging the coated substrate for the optical signal after subjecting the coated substrate to the catalysis conditions, wherein presence of an optical signal in one or more regions of the coated substrate is indicative of catalysts of the plurality of catalyst in the one or more regions being active for the target catalytic activity and/or selectivity.

2. The method of claim 1, wherein the polymer thin film comprises a polymeric backbone and the one or more reactive probes are attached to the polymeric backbone such that the reactive probes are insoluble during catalysis.

3. The method of claim 1, wherein the one or more reactive probes react irreversibly with the product of the target catalytic activity to render the fluorophore fluorescent.

4. The method of claim 1, wherein the target catalytic activity results in multiple products and the polymer thin film comprises different reactive probes, each capable of detecting a different one of the multiple products of the target catalytic activity.

5. The method of claim 1, wherein the signaling component is a fluorophore, and wherein the fluorophore is non-fluorescent until the reaction of the one or more reactive probes with the product of the target catalytic activity and/or selectivity.

6. The method of claim 5, wherein the reactive probes comprise fluorophores attached to boronate esters, the target catalytic activity is oxygen reduction reaction for which H₂O₂ is the product, and upon reaction of the reactive probes with H₂O₂, the boronate ester oxidizes allowing the fluorophore to fluoresce, optionally wherein the reactive probe is naphthalimide boronate.

7. The method of claim 1, wherein the target catalytic activity is CO₂ reduction reaction, and one or more of CO, HCO₂H, CH₂O, CH₃OH, CH₄, C₂H₄, C₂H₅OH, and CH₃CO₂H is the product with which the one or more reactive probes reacts.

8. The method of claim 1, further comprising imaging the coated pattern for optical signal intensity, wherein optical signal intensity corresponds to catalyst turnover.

9. The method of claim 9, wherein the optical signal intensity is a fluorescence intensity.

10. The method of claim 1, wherein the plurality of catalysts comprises one or more of Au, Ag, Cu, Pt, Pd, Ni, Co, Sn, and alloys thereof.

11. The method of claim 1, further comprising forming a pattern of the plurality catalysts on the substrate before coating the substrate with the polymer thin film.

12. (canceled)

13. The method of claim 1, wherein at least a portion of the plurality of catalyst differ in one or more of composition, catalyst concentration, geometry, and size.

14. A method of simultaneously testing catalytic activity of a plurality of catalyst, comprising:
depositing a plurality of nanoreactors on a substrate and subjecting the nanoreactors to conditions sufficient to form a catalyst within each of the nanoreactors, each catalyst being tested for a target catalytic activity;
attaching one or more reactive probes to each of the plurality of nanoreactors, each reactive probe comprising a signaling component that generates an optical signal upon reaction of the one or more reactive probes with a product of the target catalytic activity, thereby allowing sensing and signaling of the product of the target catalytic activity;
subjecting the plurality of nanoreactors having the catalyst formed therein and the reactive probes attached thereto to conditions corresponding to the target catalytic activity;
imaging the substrate for the optical signal after subjecting the plurality of nanoreactors to the catalysis conditions, wherein presence of the optical signal is indicative of catalysts in the corresponding region of the optical signal being active for the target catalytic activity.

15. The method of claim 15, wherein each of the plurality of nanoreactors comprises a polymer, the method further comprising cross-linking the polymer after the catalysts is formed within the nanoreactor and before attaching the one or more reactive probes.

16. The method of claim 15, wherein at least two reactive probes are attached to each nanoreactor, each of the two reactive probes being capable of reacting with different products of the target catalytic activity, optionally wherein each of the at least two reactive probes comprise fluorophores capable of fluorescing at different wavelengths.

17. (canceled)

18. The method of claim 15, wherein the signaling component is a fluorophore.

19. A method of analyzing catalysts stability, comprising:
depositing a plurality of catalysts on a substrate, each of the catalysts comprising a metal cation;
coating substrate having the plurality of catalysts with a polymer thin film comprising one or more reactive probes to form a coated substrate, each reactive probe comprising a signaling component that generates an optical signal upon reaction of the one or more reactive probes with the metal cation, thereby allowing sensing and signaling of catalyst degradation through metal cation loss;
subjecting the coated substrate to catalysis conditions;
imaging the coated substrate for the optical signal after subjecting the coated pattern to the catalysis conditions, wherein presence of the optical signal in one or more regions of the coated substrate is indicative of loss of metal cations during catalysis and thereby catalysts instability.

20. The method of claim 20, wherein the metal cation comprises cations of one or more of Au, Ag, Cu, Pt, Pd, Ni, Co, and Sn.

21. (canceled)

22. The method of claim 22, wherein at least a portion of the plurality of catalyst differ in one or more of composition, metal cation concentration, geometry, and size.

23. (canceled)

24. A method of monitoring a catalysis reaction, comprising:
depositing a plurality of nanoreactors on a substrate and subjecting the nanoreactors to conditions sufficient to form a catalyst within each of the nanoreactors, each catalyst capable of generating target catalytic activity, wherein the target catalytic activity results in a change of pH around the nanoreactors;
attaching one or more pH-sensitive signaling components to each of the plurality of nanoreactors, each pH-sensitive signaling components having an optical signal intensity that increases or decreases with the change in pH resulting from the target catalytic activity;
subjecting the plurality of nanoreactors having the catalyst formed therein and the one or more pH-sensitive signaling components attached thereto to conditions corresponding to the target catalytic activity;
imaging the substrate for the optical signal after subjecting the plurality of nanoreactors to the catalysis conditions, wherein the target catalytic activity is characterized through the change in the optical signal intensity resulting from change in pH from the target catalytic activity.

25. (canceled)

26. (canceled)

27. (canceled)

28. (canceled)

29. (canceled)

30. (canceled)

31. (canceled)

32. (canceled)

33. (canceled)
